(19) United States
(12) Patent Application Publication
(10) Pub. No.: US 2025/0357971 A1
(43) Pub. Date: Nov. 20, 2025

(54) MULTIPLE TIMING SOURCE-SYNCHRONIZED ACCESS POINT AND RADIO UNIT FOR DAS AND RAN

(71) Applicant: CommScope Technologies LLC, Claremont, NC (US)

(72) Inventors: Suresh N. Sriram, Bangalore (IN); Sudarshana Varadappa, Bangalore (IN); Yogesh C.S, Bengaluru (IN); Narayana Reddy Korimilla, Bangalore (IN); Priyanka Gondane, Nagpur (IN); Latha Murugan, Neyveli, Cuddalore (IN); Sandeep Dikshit, Bangalore (IN); Emil Mathew Kadavil, Bangalore (IN)

(73) Assignee: CommScope Technologies LLC, Claremont, NC (US)

(21) Appl. No.: 18/872,755

(22) PCT Filed: Jun. 7, 2023
(86) PCT No.: PCT/US2023/024674

§ 371 Date: Dec. 6, 2024

(30) Foreign Application Priority Data
Jun. 8, 2022 (IN) 202241032863
Jun. 10, 2022 (IN) 202241033266

(51) Int. Cl. H04B 7/022

(52) U.S. Cl. CPC H04B 7/022

(57) ABSTRACT

One embodiment is a system having a master unit coupled to first and second base station sources having different OTA frame boundary timings, where an access point coupled to the master unit receives fronthaul data for the first and second base station sources, determines a common OTA frame boundary timing, and aligns OTA symbols and frames for the first and second base station sources to the common OTA frame boundary timing. Another embodiment is a system having a base station synchronized with a timing grandmaster and a master unit, synchronized with the timing grandmaster, coupled to the base station. The master unit determines the time of day using the synchronization, identifies a system frame and subframe number using the time of day, acquires configuration information for communications with the base station using the system frame and subframe number, and identifies frame boundary timing using the configuration information.

### CROSS-REFERENCE TO RELATED APPLICATIONS

This application claims priority to Indian Provisional Application No. 202241032863, filed on Jun. 8, 2022, and titled “MULTIPLE TIMING SOURCE-SYNCHRONIZED ACCESS POINT AND RADIO UNIT FOR DAS AND RAN,” and to Indian Provisional Application 20/224,1033266, filed on Jun. 10, 2022, and titled “SIMPLIFIED RADIO FRAME SYNCHRONIZATION FOR RF AND DIGITAL DONORS OF DISTRIBUTED ANTENNA SYSTEM” the contents of which are hereby incorporated by reference in their entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units” or “radio units”). Each access point can be coupled directly to one or more of the central access nodes. Also, each access point can be coupled indirectly via one or more other remote units or via one or more intermediary or expansion units or nodes (also referred to here as “transport expansion nodes (TENs)”). A DAS is typically used to improve the coverage provided by one or more base stations coupled to the central access nodes. These base stations can be coupled to the one or more central access nodes via one or more cables or via a wireless connection, for example, using one or more donor antennas. The wireless service provided by the base stations can include commercial cellular service or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals for radiation from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits the one or more uplink transport signals to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, receiving the uplink signals involves, among other things, summing uplink signals received from the multiple access points to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Traditionally, a DAS is operated in a “full simulcast” mode in which downlink signals for each base station are transmitted from multiple access points of the DAS and in which uplink signals for each base station are generated by summing uplink data received from the multiple access points.

The 3GPP fifth generation (5G) radio access network (RAN) architecture includes a set of base stations (also referred to as “gNBs”) connected to the 5G core network (5GC) and to each other. Each gNB typically comprises three entities-a centralized unit (CU), a distributed unit (DU), and a set of one or more radio units (RUs). The CU can be further split into one or more CU control plane entities (CU-CPs) and one or more CU user plane entities (CU-UPs). The functions of the RAN can be split among these entities in various ways. For example, the functional split between the DU and the RUs can be configured so that the DU implements some of the Layer-1 processing functions (for the wireless interface), and each RU implements the Layer-1 functions that are not implemented in the DU as well as the basic RF and antenna functions. The DU is coupled to each RU using a fronthaul network (for example, one implemented using a switched Ethernet network) over which data is communicated between the DU and each RU. The data includes, for example, user-plane data (for example, in-phase and quadrature (IQ) data representing time-domain or frequency-domain symbols). One example of such a configuration is a “cloud radio access network” or “cloud RAN” configuration in which each CU and DU are associated with multiple RUs.

Further, traditional base stations have been coupled to a DAS via the analog RF interface that would otherwise be used to couple the base station to a set of antennas. Also, some DASs have the capability to be coupled to a baseband unit (BBU) via a CPRI interface. In either case, the DAS is typically outside of the control-plane and management-plane domain of the base stations coupled to it. Therefore, in order to configure the DAS for use with the base stations coupled to it, information about the base station must either be manually entered (for example, using a management system for the DAS) or the DAS must include a measurement or sniffer receiver that implements the cell search procedure that user equipment (UE) typically performs in order to synchronize itself to the cell supported by each base station and decode the configuration information broadcast by the base station. In particular, this functionality is used by the DAS to automatically decode the MIB and SIB broadcast by the base station and in order to obtain the configuration information for that base station.

### SUMMARY

A system for a multiple timing source-synchronized access point and radio unit for das and ran includes a master unit coupled to a first base station source and a second base station source, the first base station source having OTA frame boundary timing that differs from the second base station source. The system also includes at least one access point coupled to the master unit. Further, the at least one access point is configured to receive fronthaul data for both the first base station source and the second base station source. Also, the at least one access point is configured to determine a common OTA frame boundary timing. Moreover, the at least one access point is configured to align OTA symbols and frames for the first base station source and the second base station source to the common OTA frame boundary timing.

A system for simplified radio frame synchronization for rf and digital donors of distributed antenna system includes a timing grandmaster. The system also includes at least one base station that is synchronized with the timing grandmaster. Further, the system includes a master unit coupled to the at least one base station, wherein the master unit is synchronized with the timing grandmaster. The master unit is configured to determine the time of day based on the synchronization with the timing grandmaster. Also, the master unit is configured to identify a system frame number and a subframe number based on the time of day. Additionally, the master unit is configured to acquire configuration information for communications with the at least one base station based on the system frame number and the subframe number. Moreover, the master unit is configured to identify frame boundary timing based on the acquired configuration information.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIGS. 1A-1C are block diagrams illustrating exemplary embodiments of a virtualized DAS according to an aspect of the present disclosure;

FIG. 2 is a block diagram illustrating an exemplary embodiment of an access point for use in a virtualized DAS according to an aspect of the present disclosure;

FIGS. 3A-3D are block diagrams illustrating exemplary embodiments of a virtualized DAS having access points coupled to virtual MUs according to an aspect of the present disclosure;

FIG. 4 is a block diagram illustrating an exemplary embodiment of a virtualized DAS where an RF interface bypasses a virtualized MU according to an aspect of the present disclosure;

FIG. 5 is a block diagram illustrating components of a DAS that sysnchronize with a base station according to an aspect of the present disclosure;

FIGS. 6A and 6B are flowcharts of a method for synchronizing a DAS with a base station according to an aspect of the present disclosure;

FIG. 7 is a diagram of a DAS that receives data from multiple sources having different timing profiles according to an aspect of the present disclosure;

FIGS. 8A and 8B are diagrams illustrating different timing profiles for data received from different sources according to an aspect of the present disclosure;

FIG. 9 is a diagram illustrating the use of a buffer for aligning frames to a common frame boundary timing according to an aspect of the present disclosure;

FIG. 10 is a block diagram of an exemplary embodiment of a RAN according to an aspect of the present disclosure;

FIG. 11 is a flowchart diagram of a method for aligning frames and symbols with a common frame boundary timing according to an aspect of the present disclosure; and

FIG. 12 is a flowchart diagram of a method for synchronizing a DAS with a base station according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods for synchronizing multiple timing sources for transmission through an access point or radio unit of a DAS, RAN system, or other similar system are described herein. In particular, the embodiments described herein enable an access point or radio unit of a DAS or RAN to be used with multiple, different types of sources (such as RF and packet-based sources). In particular, the DAS or RAN is able to identify an over the air (OTA) frame boundary timing for one or more sources, select the OTA frame boundary from one of the sources as a common OTA frame boundary, and then synchronize the OTA frames, subframes, slots, symbols, etc. for the multiple different sources to the common OTA frame boundary.

As described herein, base stations can function as different types of sources, an “RF source” refers to a base station coupled to a DAS using an analog RF interface. A “CPRI Source” refers to, in the case of a DAS embodiment, a BBU of a base station that is coupled to a DAS using a CPRI interface and, in the case of a RAN embodiment, a BBU that is coupled to a radio unit of the RAN using a CPRI interface. A “packet-based source” refers to, in the case of a DAS embodiment, a DU of a base station that is coupled to a DAS using an O-RAN, eCPRI, or RoE interface and, in the case of a RAN embodiment, a DU that is coupled to a radio unit of the RAN using an O-RAN, eCPRI, or RoE interface. Each of these can also be referred to generally as a “source.”

Wireless interfaces (such as 4G LTE or 5G NR) typically require that each access point of a DAS and each RU of a RAN align OTA radio frames transmitted from the DAS with a master clock (also referred to as a “grandmaster” or “GM”) to avoid interference with neighboring base stations. The alignment of OTA radio frames can be done in various ways—for example, using GPS, PTP, NTP, or Synchronous Ethernet (SyncE) protocols or technology. For example, in the case of an RF Source or a CPRI source, the OTA radio frames transmitted from an access point of a DAS can be synchronized to a grandmaster using SyncE. In the case of a packet-based source, the OTA radio frames transmitted from an access point of a DAS can be synchronized to a grandmaster using PTP or NTP.

As noted above, the DAS may perform signal processing to decode the MIB and SIB information like the UE cell search procedure. As a part of performing the signal processing to decode the MIB and SIB, the DAS may perform a frame synchronization. Typically, the frame synchronization performance includes the performance of a frequency scan in which the channel raster for a given frequency band is scanned and correlated with all possible cell identifiers (Cell_IDs) to identify a frame boundary. Performing the scan for identifying the frame boundary may be computationally and time intensive. However, when the configuration of a base station coupled to a DAS changes, the time needed to identify the frame boundary can affect the ability of the DAS to quickly decode the new cell configuration so that the DAS can reconfigure itself to limit disruptions in wireless service being provided for that base station via the DAS.

Further, it is often the case that the access point of a DAS or an RU of a RAN transmits signals sourced from multiple sources. Because of the need to align the OTA radio frames sourced from multiple sources, it is typically a requirement that such multi-source access points or RUs be used with only a single type of source (for example, used with only RF sources or used with only packet-based sources). The requirement for a single source type arises because different types of sources typically have different timing profiles. Further, timing issues can arise if a single access point of a DAS or a single RU of a RAN serve multiple sources from different wireless operators.

For example, where a single access point of a DAS is used to transmit radio frames from a packet-based source and radio frames from an RF Source, the DAS may receive the IQ data from the different sources in different ways. For example, an O-RAN source may provide frequency-domain IQ data having meaningful jitter between the packets, where synchronization may be achieved using a protocol such as NTP or PTP. However, an RF Source (or a CPRI Source) may provide time-domain IQ data as a synchronous stream of IQ data that includes IQ data for each sample period, where synchronization is achieved using SyncE.

To facilitate synchronization, systems and methods described herein determine a common OTA frame boundary timing for use at an access point. The access point may then cause the OTA frames, subframes, slots, symbols, etc. from the different sources to be synchronized to the common OTA frame boundary timing.

In some embodiments, the DAS may identify the frame boundary by first synchronizing an entity of the DAS (for example, an RF donor (RFD), CPRI donor (CPD), or master unit (MU)) to a timing source that is either the same timing source used by the associated base station source or a different timing source that is sufficiently close to the timing source used by the base station source. For example, the different timing source may be sufficiently close when the timing between the two sources is within an amount required by an OTA time profile (for example, within +/−3 microseconds, which is within a symbol period of a 4G LTE and 5G NR system)). The entity of the DAS can be synchronized to the timing source using, for example, the PTP protocol. Although embodiments described herein refer to PTP based synchronization it is to be understood that other synchronization protocols or sources can be used (for example, GPS, NTP, SyncE, etc.). After synchronizing to such a timing source, the entity of the DAS and the base station will be synchronized with respect to the radio frame boundary.

In certain embodiments, the entity of the DAS may derive the Time of Day which can be used to determine the System Frame Number (SFN), subframe number (SF), and slot number (for example, using the procedures described in the relevant 3GPP Technical Specifications). By determining the SFN, SF, and slot number from the timing information (for example, from the PTP information), the incoming RF IQ provided from an RF source (via a RFD) or a CPRI source (via a CPD), or from an O-RAN source (connected directly to an MU) can be decoded starting from a specific frame boundary. Thus, the DAS can avoid performing a frequency scan in which the channel raster for a given frequency band is scanned and correlated with all possible Cell IDs to identify the frame boundary. The identified frame boundary associated with the base station can then be designated as a common OTA frame boundary or synchronized to common OTA frame boundary as described herein.

In embodiments, where an RF Source provides data to the access point, the access point may select the OTA frame boundary for the RF source as the common OTA frame boundary. After selecting the OTA frame boundary for the RF source as the OTA frame boundary, the access point may align the OTA frames, subframes, slots, and symbols from the other non-RF sources to the selected OTA frame boundary. That is, transmission of OTA frames, subframes, slots, and symbols from the different sources are aligned to the OTA frame boundary.

In some embodiments, to facilitate the aligning of IQ data received from packet-based sources to a common OTA frame boundary, a system may include a buffer (such as a circular buffer). The buffer may store IQ data for symbols received from the packet-based source as they are received and the IQ data is output from the circular buffer in accordance with the timing established by the common OTA frame boundary determined from the RF Source. In some systems, DUs and BBUs are able to communicate with the DAS and/or access points, such that the DUs and BBUs have functionality to learn about and compensate for timing delays. Thus, the DUs or BBUs of packet-based sources may learn about and compensate for timing delays caused by the use of the circular buffer.

Further, systems and methods described herein may be used to synchronize OTA frame boundary timing when an access point receives IQ data from multiple packet-based sources having different OTA frame boundary timing. When the access point receives data from multiple packet-based sources, the access point may select the OTA frame boundary timing of one of the sources, averaging the OTA frame boundary timing from the multiple packet-based sources, or performing other methods for selecting an OTA frame boundary timing. When the OTA frame boundary timing is selected, the packets may be received and stored in a buffer.

The techniques described herein can be used with both multi-source access points of a DAS and multi-source RUs of a RAN. Other embodiments can be implemented in other ways. Further, the techniques can be used in a digital DAS. For example, the techniques can be used in a virtualized DAS as described below. Additionally, the techniques can be used in other types of DASs such as more traditional DASs (for example, non-virtualized DASs) and other non-DAS communications systems, where a device receives sources from multiple sources having different timing boundaries.

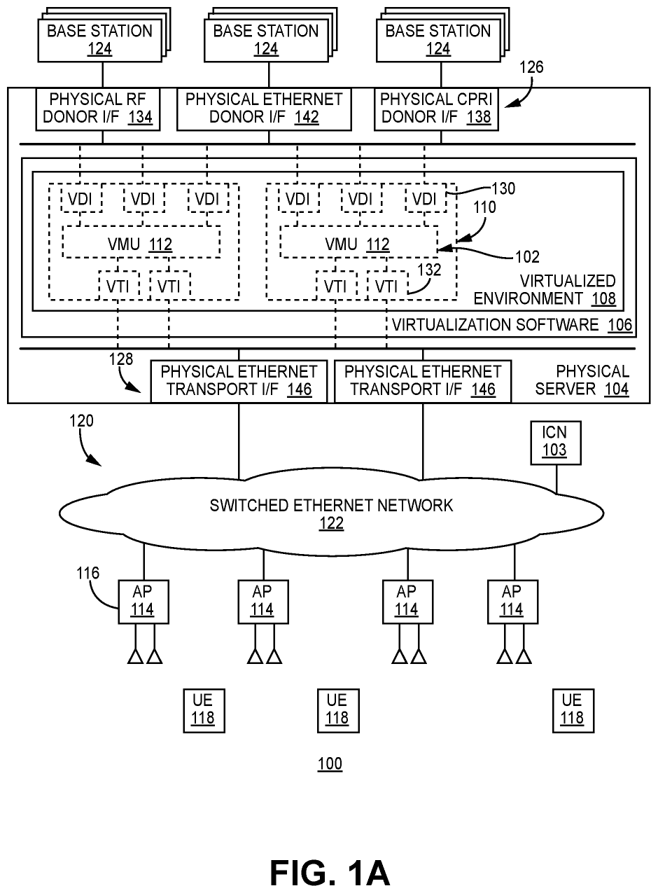

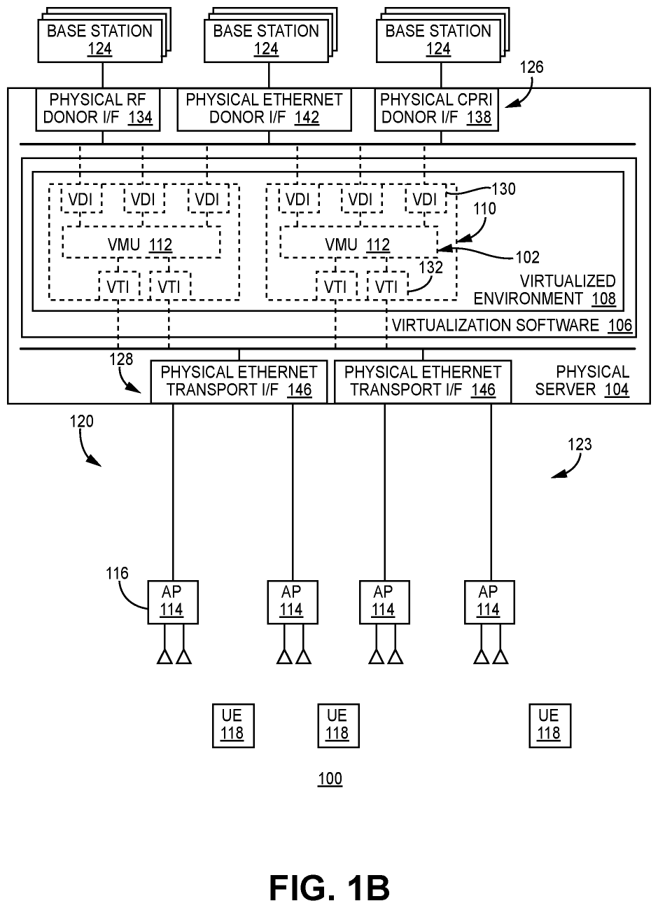

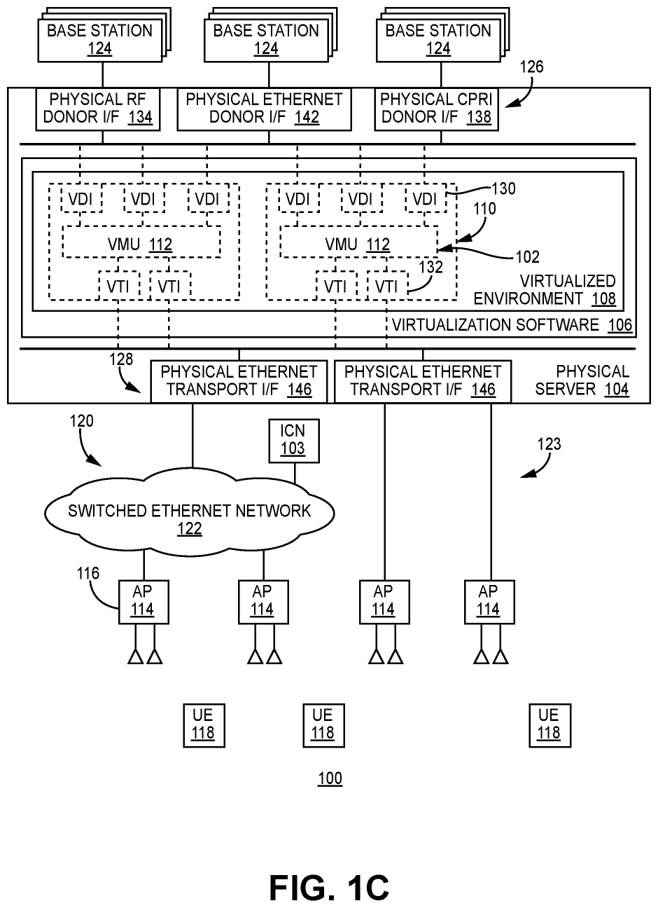

FIGS. 1A-1C are block diagrams illustrating one exemplary embodiment of a virtualized DAS (vDAS) 100. In the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software that is configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 in order to provide a virtualized environment 108 in which one or more one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred here to as “remote antenna units” (RAUs) or “radio units” (RUs)) 114. Each vMU 112 is configured to implement at least some of the functions normally carried out by a physical master unit or CAN in a traditional DAS.

Each of the vMU 112 is implemented as a respective VNF 102 deployed on one or more of the physical servers 104. Each of the APs 114 is implemented as a physical network function (PNF) and is deployed in or near a physical location where coverage is to be provided.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Although only two coverage antennas 116 are shown in FIGS. 1A-1C for ease of illustration, it is to be understood that other numbers of coverage antennas 116 can be used. Each of the APs 114 is communicatively coupled to the respective one or more vMU 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it using at least some shared communication links.

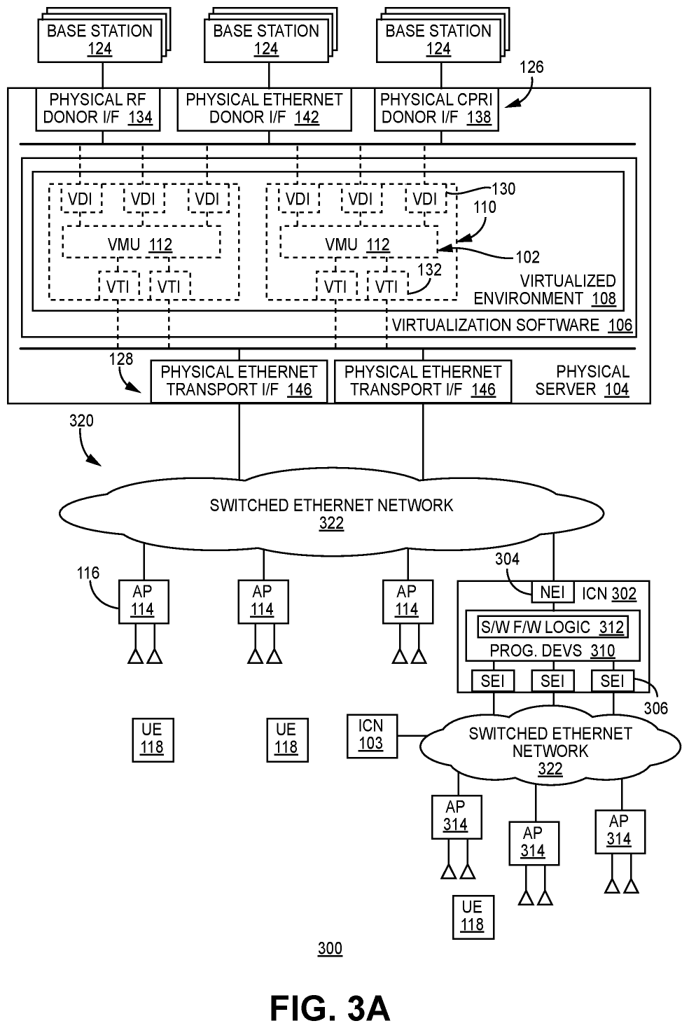

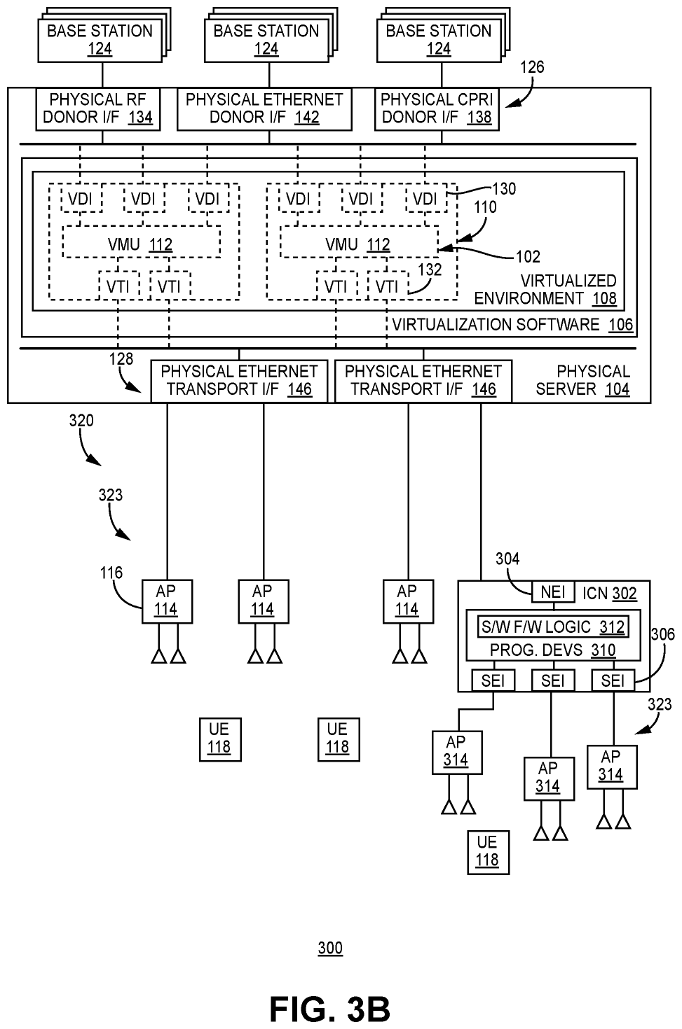

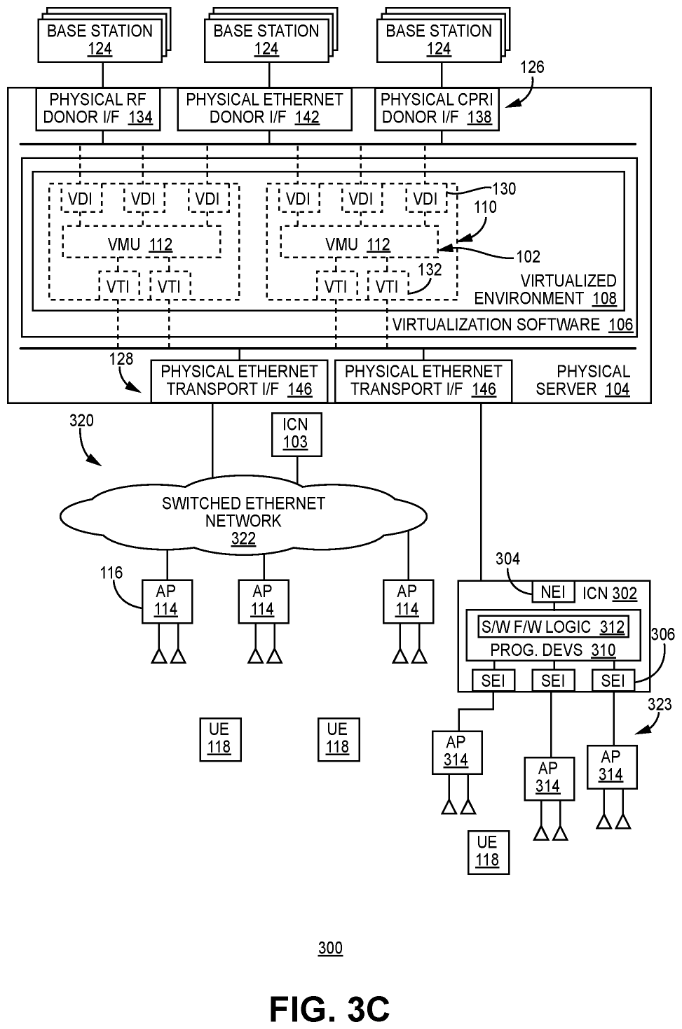

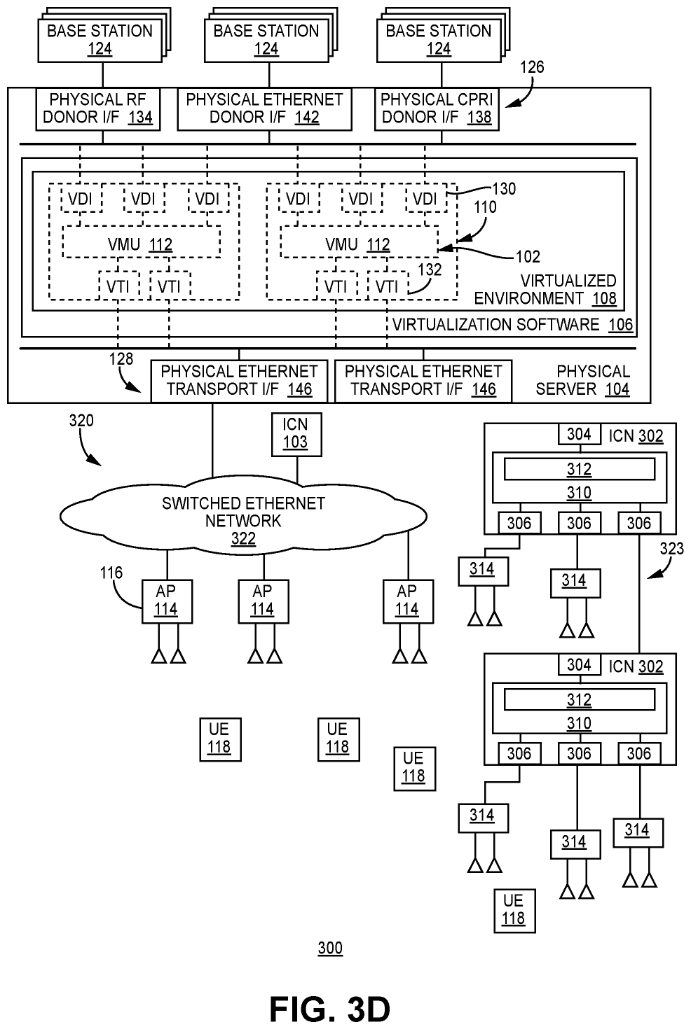

In the example shown in FIG. 1B, the fronthaul network 120 is implemented using only point-to-point Ethernet links 123, where each AP 114 is coupled to each serving vMU 112 serving it via a respective one or more point-to-point Ethernet links 123. In the example shown in FIG. 1C, the fronthaul network 120 is implemented using a combination of a switched Ethernet network 122 and point-to-point Ethernet links 123, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 123. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124 in order to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an O-RAN fronthaul interface) and different functional splits can be supported (including, for example, functional split 8, functional split 7-2, and functional split 6). The O-RAN Alliance publishes various specifications for implementing RANs in an open manner. (“O-RAN” is an acronym that also stands for “Open RAN,” but in this description references to “O-RAN” should be understood to be referring to the O-RAN Alliance and/or entities or interfaces implemented in accordance with one or more specifications published by the O-RAN Alliance.)

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for use in such deployments because vMUs 112 can be easily instantiated in order to support additional wireless service operators. This is the case even if an additional physical server computer 104 is needed in order to instantiate a new vMU 112 because such physical server computers 104 are either already available in such deployments or can be easily added at a low cost (for example, because of the COTS nature of such hardware). Other vDAS entities implemented in virtualized manner (for example, ICNs) can also be easily instantiated or removed as needed based on demand.

In the example shown in FIGS. 1A-1C, the physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114 and ICNs). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes or is in communication with separate physical donor and transport interfaces 126 and 128; however, it is to be understood that in other embodiments a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

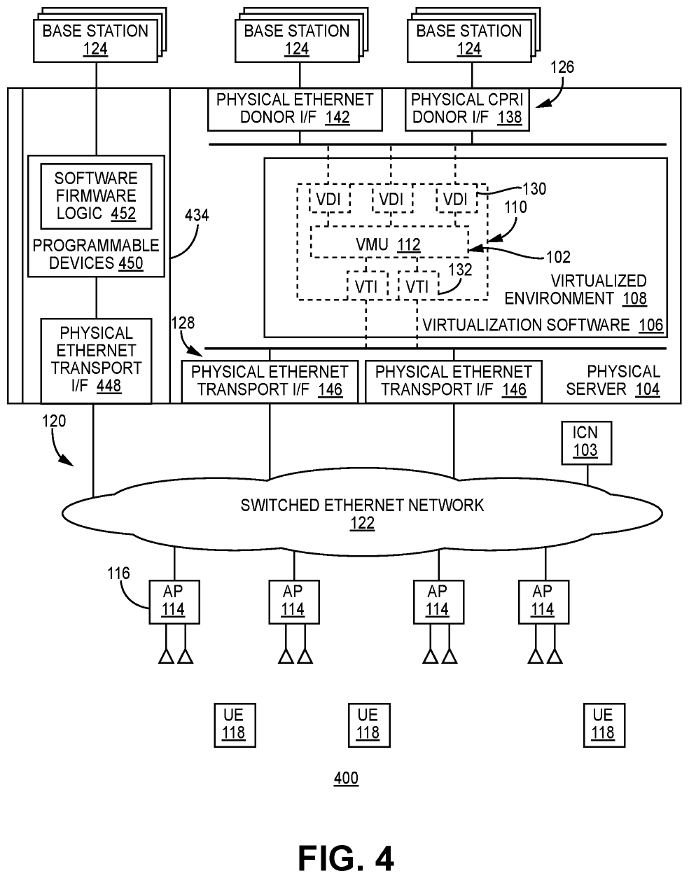

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by implementing the physical RF donor interface 134 as a card inserted in the physical server computer 104 and communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain user-plane data, and output it to a vMU 112 executing on the same server computer 104 in which that RF donor interface 134 is deployed. Also, each physical RF donor interface 134 is configured, for each base station 124 coupled to it, to receive combined uplink time-domain user-plane data from the vMU 112 for that base station 124, convert the received combined uplink time-domain user-plane data to uplink analog RF signals, and output them to the base station 124. Moreover, the digital downlink time-domain user-plane data produced, and the digital uplink time-domain user-plane data received, by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to by-pass the vMU 112 and instead, for the base stations 124 coupled to that physical RF donor interface, have that physical RF donor interface perform some of the functions described here as being performed by the vMU 112 (including the digital combining or summing of user-plane data).

In the exemplary embodiment shown in FIGS. 1A-1C, the physical donor interfaces 126 also comprise one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by implementing the physical CPRI donor interface 138 as a card inserted in the physical server computer 104 and communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU that is configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive digital uplink data including combined digital user-plane data from the vMU 112, format it for the CPRI fronthaul interface, and output the CPRI formatted data to the base station 124 via the CPRI ports.

In the exemplary embodiment shown in FIGS. 1A-1C, the physical donor interfaces 126 also comprise one or more physical donor Ethernet interfaces 142. Each physical donor Ethernet interface 142 is in communication with one or more vMUs 112 executing on the physical server computer 104 in which that physical donor Ethernet interface 142 is deployed (for example, by implementing the physical donor Ethernet interface 142 as a card or module inserted in the physical server computer 104 and communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU that is configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive digital uplink fronthaul data including combined digital user-plane data for the base station 124 from the vMU 112, output it to the base station 124 via one or more Ethernet ports 144. In some implementations, each physical donor Ethernet interface 142 is implemented using standard Ethernet interfaces of the type typically used with COTS physical servers.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by implementing the physical transport Ethernet interface 146 as a card or module inserted in the physical server computer 104 and communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114 and ICNs. In some implementations, each physical transport Ethernet interface 146 is implemented using standard Ethernet interfaces of the type typically used with COTS physical servers.

In this exemplary embodiment, the virtualization software 106 is configured to implement within the virtual environment 108 a respective virtual interface for each of the physical donor interfaces 126 and physical transport Ethernet interfaces 146 in order to provide and control access to the associated physical interface by each vMU 112 implemented within that virtual environment 108. That is, the virtualization software 106 is configured so that the virtual entity 110 used to implement each vMU 112 includes or communicates with a virtual donor interface (VDI) 130 that virtualizes and controls access to the underlying physical donor interface 126. Each VDI 130 can also be configured to perform some donor-related signal or other processing (for example, each VDI 130 can be configured to process the user-plane and/or control-plane data provided by the associated physical donor interface 126 in order to determine timing and system information for the base station 124 and associated cell). Also, although each VDI 130 is illustrated in the examples shown in FIGS. 1A-1C as being separate from the respective vMU 112 with which it is associated, it is to be understood that each VDI 130 can also be implemented as a part of the vMU 112 with which it is associated. Likewise, the virtualization software 106 is configured so that the virtual entity 110 used to implement each vMU 112 includes or communicates with a virtual transport interface (VTI) 132 that virtualizes and controls access to the underlying physical transport interface 128. Each VTI 132 can also be configured to perform some transport-related signal or other processing. Also, although each VTI 132 is illustrated in the examples shown in FIGS. 1A-1C as being separate from the respective vMU 112 with which it is associated, it is to be understood that each VTI 132 can also be implemented as a part of the vMU 112 with which it is associated. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

The vDAS 100 is configured to serve each base station 124 using a respective subset of APs 114 (which may include less than all of the APs 114 of the vDAS 100). The subset of APs 114 used to serve a given base station 124 is also referred to here as the “simulcast zone” for that base station 124. Typically, the simulcast zone for each base station 124 includes multiple APs 114. In this way, the vDAS 100 increases the coverage area for the capacity provided by the base stations 124. Different base stations 124 (including different base stations 124 from different wireless service operators in deployments where multiple wireless service operators share the same vDAS 100) can have different simulcast zones defined for them. Also, the simulcast zone for each served base station 124 can change (for example, based on a time of day, day of the week, etc., and/or in response to a particular condition or event).

In general, the wireless coverage of a base station 124 served by the vDAS 100 is improved by radiating a set of downlink RF signals for that base station 124 from the coverage antennas 116 associated with the multiple APs 114 in that base station's simulcast zone and by producing a single set of uplink base station signals by a combining or summing process that uses inputs derived from the uplink RF signals received via the coverage antennas 116 associated with the multiple APs 114 in that base station's simulcast zone, where the resulting final single set of uplink base station signals is provided to the base station 124.

This combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114). Each unit of the vDAS 100 that performs the combining or summing process for a given base station 124 receives uplink transport data for that base station 124 from that unit's one or more “southbound” entities, combines or sums corresponding user-plane data contained in the received uplink transport data for that base station 124 as well as any corresponding user-plane data generated at that unit from uplink RF signals received via coverage antennas 116 associated with that unit (which would be the case if the unit is a “daisy-chained” AP 114), generates uplink transport data containing the combined user-plane data for that base station 124, and communicates the resulting uplink transport data for that base station 124 to the appropriate “northbound” entities coupled to that unit. As used here, “southbound” refers to traveling in a direction “away,” or being relatively “farther,” from the vMU 112 and base station 124, and “northbound” refers to traveling in a direction “towards,” or being relatively “closer” to, the vMU 112 and base station 124. As used here, the southbound entities of a given unit are those entities that are subtended from that unit in the southbound direction, and the northbound entities of a given unit are those entities from which the given unit is itself subtended from in the southbound direction.

The vDAS 100 can also include one or more intermediary or intermediate combining nodes (ICNs) (also referred to as “expansion” units or nodes). For each base station 124 that the vDAS 100 serves using an ICN, the ICN is configured to receive a set of uplink transport data containing user-plane data for that base station 124 from a group of southbound entities (that is, from APs 114 and/or other ICNs) and perform the uplink combining or summing process described above in order to generate uplink transport data containing combined user-plane data for that base station 124, which the ICN transmits northbound towards the vMU 112 serving that base station 124. Each ICN also forwards northbound all other uplink transport data (for example, uplink management-plane and synchronization-plane data) received from its southbound entities. In the embodiments shown in FIGS. 1A, 1C, 3A, 3C, and 3D, the ICN 103 is communicatively coupled to its northbound entities and its southbound entities using the switched Ethernet network 122 and is used only for communicating uplink transport data and is not used for communicating downlink transport data. In such embodiments, each ICN 103 includes one or more Ethernet interfaces to communicatively couple the ICN 103 to the switched Ethernet network 122. For example, the ICN 103 can include one or more Ethernet interfaces that are used for communicating with its northbound entities and one or more Ethernet interfaces that are used for communicating with its southbound entities. Alternatively, the ICN 103 can communicate with both its northbound and southbound entities via the switched Ethernet network 122 using the same set of one or more Ethernet interfaces.

In some embodiments, the vDAS 100 is configured so that some ICNs also communicate (forward) southbound downlink transport data received from their northbound entities (in addition to communicating uplink transport data). In the embodiments shown in FIGS. 3A-3D, the ICNs 302 are used in this way. The ICNs 302 are communicatively coupled to their northbound entities and their southbound entities using point-to-point Ethernet links 123 and are used for communicating both uplink transport data and downlink transport data.

Generally, ICNs can be used to increase the number of APs 114 that can be served by a vMU 112 while reducing the processing and bandwidth load relative to having the additional APs 114 communicate directly with the vMU 112. Each ICN can be implemented as a physical network function using dedicated, special-purpose hardware. Alternatively, each ICN can be implemented as a virtual network function running on a physical server. For example, each ICN can be implemented in the same manner as the vMU 112.

Also, one or more APs 114 can be configured in a “daisy-chain” or “ring” configuration in which transport data for at least some of those APs 114 is communicated via at least one other AP 114. Each such AP 114 would also perform the user-plane combining or summing process described above for any base station 124 served by that AP 114 in order to combine or sum user-plane data generated at that AP 114 from uplink RF signals received via its associated coverage antennas 116 with corresponding uplink user-plane data for that base station 124 received from any southbound entity subtended from that AP 114. Such an AP 114 also forwards northbound all other uplink transport data received from any southbound entity subtended from it and forwards to any southbound entity subtended from it all downlink transport received from its northbound entities.

In general, the vDAS 100 is configured to receive a set of downlink base station signals from each served base station 124, generate downlink base station data for the base station 124 from the set of downlink base station signals, generate downlink transport data for the base station 124 that is derived from the downlink base station data for the base station 124, and communicate the downlink transport data for the base station 124 over the fronthaul network 120 of the vDAS 100 to the APs 114 in the simulcast zone of the base station 124. Each AP 114 in the simulcast zone for each base station 124 is configured to receive the downlink transport data for that base station 124 communicated over the fronthaul network 120 of the vDAS 100, generate a set of downlink analog radio frequency (RF) signals from the downlink transport data, and wirelessly transmit the set of downlink analog RF signals from the respective set of coverage antennas 116 associated with that AP 114. The downlink analog RF signals are radiated for reception by UEs 118 served by the base station 124. As described above, the downlink transport data for each base station 124 can be communicated to each AP 114 in the base station's simulcast zone via one or more intermediary units of the vDAS 100 (such as one or more ICNs or daisy-chained APs 114). Also, as described above, if an AP 114 is part of a daisy chain, the AP 114 will also forward to any southbound entity subtended from that AP 114 all downlink transport received from its northbound entities.

The vDAS 100 is configured so that a vMU 112 associated with at least one base station 124 performs at least some of the processing related to generating the downlink transport data that is derived from the downlink base station data for that base station 124 and communicating the downlink transport data for the base station 124 over the fronthaul network 120 of the vDAS 100 to the APs 114 in the simulcast zone of the base station 124. In exemplary embodiments shown in FIGS. 1A-1C, a respective vMU 112 does this for all of the served base stations 124.

In general, each AP 114 in the simulcast zone of a base station 124 receives one or more uplink RF signals transmitted from UEs 118 being served by the base station 124. Each such AP 114 generates uplink transport data derived from the one or more uplink RF signals and transmits it over the fronthaul network 120 of the vDAS 100. As noted above, as a part of doing this, if the AP 114 is a part of a daisy chain, the AP 114 performs the user-plane combining or summing process described above for the base station 124 in order to combine or sum user-plane data generated at that AP 114 from uplink RF signals received via its associated coverage antennas 116 for the base station 124 with any corresponding uplink user-plane data for that base station 124 received from any southbound entity subtended from that AP 114. Such a daisy-chained AP 114 also forwards northbound to its northbound entities all other uplink transport data received from any southbound entity subtended from that AP 114. As described above, the uplink transport data for each base station 124 can be communicated from each AP 114 in the base station's simulcast zone over the fronthaul network 120 via one or more intermediary units of the vDAS 100 (such as one or more ICNs or daisy-chained APs 114).

The vDAS 100 is configured to receive uplink transport data for each base station 124 from the fronthaul network 120 of the vDAS 100, use the uplink transport data for the base station 124 received from the fronthaul network 120 of the vDAS 100 to generate uplink base station data for the base station 124, generate a set of uplink base station signals from the uplink base station data for the base station 124, and provide the uplink base station signals to the base station 124. As a part of doing this, the user-plane combining or summing process can be performed for the base station 124.

The vDAS 100 is configured so that a vMU 112 associated with at least one base station 124 performs at least some of the processing related to using the uplink transport data for the base station 124 received from the fronthaul network 120 of the vDAS 100 to generate the uplink base station data for the base station 124. In exemplary embodiments shown in FIGS. 1A-1C, a respective vMU 112 does this for all of the served base stations 124. As a part of performing this processing, the vMU 112 can perform at least some of the user-plane combining or summing processes for the base station 124.

Also, for any base station 124 coupled to the vDAS 100 using a CPRI fronthaul interface or an Ethernet fronthaul interface, the associated vMU 112 (and/or VDI 132 or physical donor interface 126) is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 (and/or VDI 132 or physical donor interface 126) is configured to implement the control-plane, user-plane, synchronization-plane, and management-plane functions that such an RU or RRH would implement. Stated another way, in this example, the vMU 112 (and/or VDI 132 or physical donor interface 126) is configured to implement a single “virtual” RU or RRH for the associated base station 124 even though multiple APs 114 are actually being used to wirelessly transmit and receive RF signals for that base station 124.

In some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100. More specifically, in some implementations, whether user-plane data is communicated over the vDAS 100 as time-domain data or frequency-domain data depends on the functional split used to couple the associated donor base station 124 to the vDAS 100. That is, where the associated donor base station 124 is coupled to the vDAS 100 using functional split 7-2 (for example, where the associated donor base station 124 comprises an O-RAN DU that is coupled to the vDAS 100 using the O-RAN fronthaul interface), transport data communicated over the fronthaul network 120 of the vDAS 100 comprises frequency-domain user-plane data and any associated control-plane data. Where the associated donor base station 124 is coupled to the vDAS 100 using functional split 8 (for example, where the associated donor base station 124 comprises a CPRI BBU that is coupled to the vDAS 100 using the CPRI fronthaul interface) or where the associated donor base station 124 is coupled to the vDAS 100 using an analog RF interface (for example, where the associated donor base station 124 comprises a “complete” base station that is coupled to the vDAS 100 using the analog RF interface that otherwise can be used to couple the antenna ports of the base station to a set of antennas), transport data communicated over the fronthaul network 120 of the vDAS 100 comprises time-domain user-plane data and any associated control-plane data.

In some implementations, user-plane data is communicated over the vDAS 100 in one form (either as time-domain data or frequency-domain data) regardless of the functional split used to couple the associated donor base station 124 to the vDAS 100. For example, in some implementations, user-plane data is communicated over the vDAS 100 as frequency-domain data regardless of the functional split used to couple the associated donor base station 124 to the vDAS 100. Alternatively, user-plane data can be communicated over the vDAS 100 as time-domain data regardless of the functional split used to couple the associated donor base station 124 to the vDAS 100. In implementations where user-plane data is communicated over the vDAS 100 in one form, user-plane data is converted as needed (for example, by converting time-domain user-plane data to frequency-domain user-plane data and generating associated control-plane data or by converting frequency-domain user-plane data to time-domain user-plane data and generating associated control-plane data as needed).

In some such implementations, the same fronthaul interface can be used for transport data communicated over the fronthaul network 120 of the vDAS 100 for all the different types of donor base stations 124 coupled to the vDAS 100. For example, in implementations where user-plane data is communicated over the vDAS 100 in different forms, the O-RAN fronthaul interface can be used for transport data used to communicate frequency-domain user-plane data and any associated control-plane data for donor base stations 124 that are coupled to the vDAS 100 using functional split 7-2 and the O-RAN fronthaul interface can also be used for transport data used to communicate time-domain user-plane data and any associated control-plane data for donor base stations 124 that are coupled to the vDAS 100 using functional split 8 or using an analog RF interface. Also, in implementations where user-plane data is communicated over the vDAS 100 in one form (for example, as frequency-domain data), the O-RAN fronthaul interface can be used for all donor base stations 124 regardless of the functional split used to couple the associated donor base station 124 to the vDAS 100.

Alternatively, in some such implementations, different fronthaul interfaces can be used to communicate transport data for different types of donor base stations 124. For example, the O-RAN fronthaul interface can be used for transport data used to communicate frequency-domain user-plane data and any associated control-plane data for donor base stations 124 that are coupled to the vDAS 100 using functional split 7-2 and a proprietary fronthaul interface can be used for transport data used to communicate time-domain user-plane data and any associated control-plane data for donor base stations 124 that are coupled to the vDAS 100 using functional split 8 or using an analog RF interface.

In some implementations, transport data is communicated in different ways over different portions of the fronthaul network 120 of the vDAS 100. For example, the way transport data is communicated over portions of the fronthaul network 120 of the vDAS 100 implemented using switched Ethernet networking can differ from the way transport data is communicated over portions of the fronthaul network 120 of the vDAS 100 implemented using point-to-point Ethernet links 123 (for example, as a described below in connection with FIGS. 3A-3D).

In the exemplary embodiment shown in FIGS. 1A-1C, the vDAS 100, and each vMU 112, ICN 103, and AP 114 thereof, is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 100. In one example, one of the vMUs 112 is configured to serve as the timing master entity for the vDAS 100, and each of the other vMUs 112 and the ICNs and APs 114 synchronizes itself to that timing master entity. In another example, a separate external timing master entity is used, and each vMU 112, ICN, and AP 114 synchronizes itself to that external timing master entity. For example, a timing master entity for one of the base stations 124 may be used as the external timing master entity.

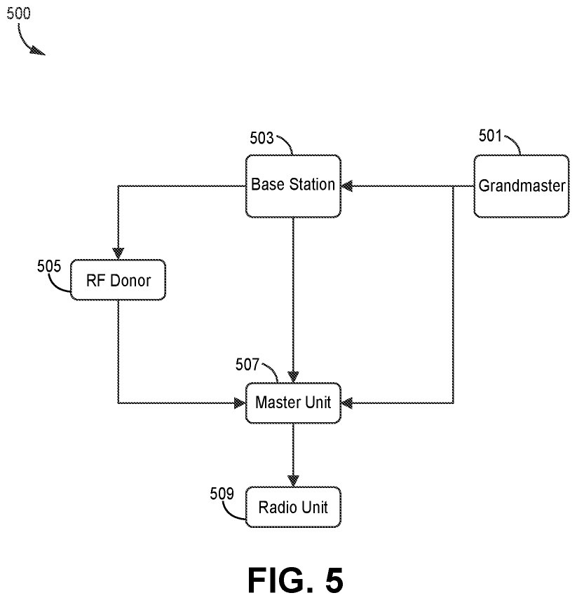

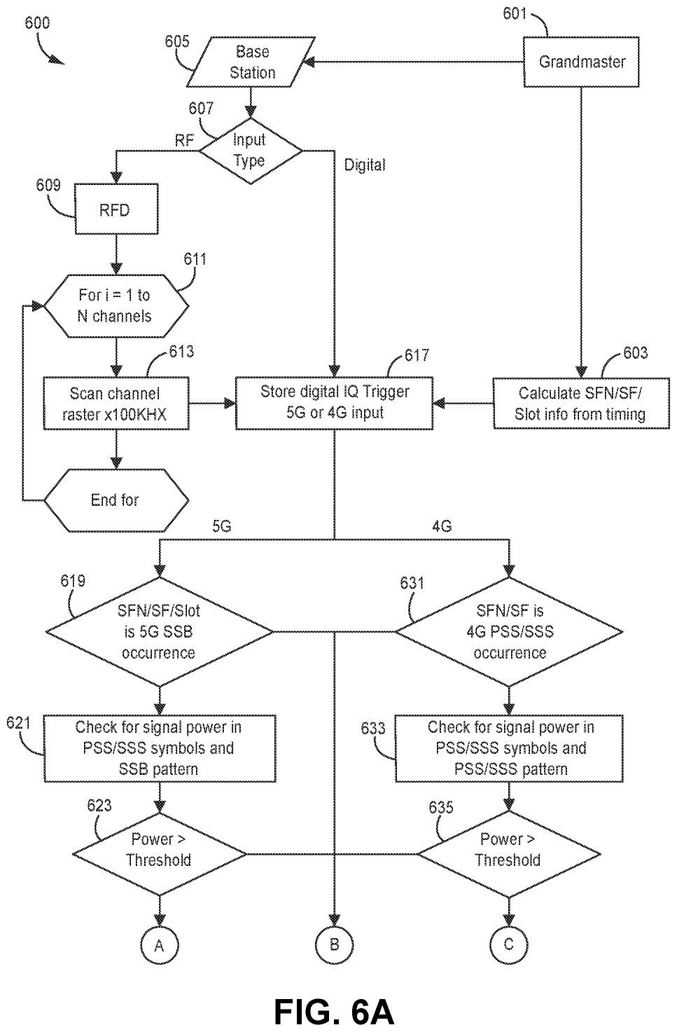

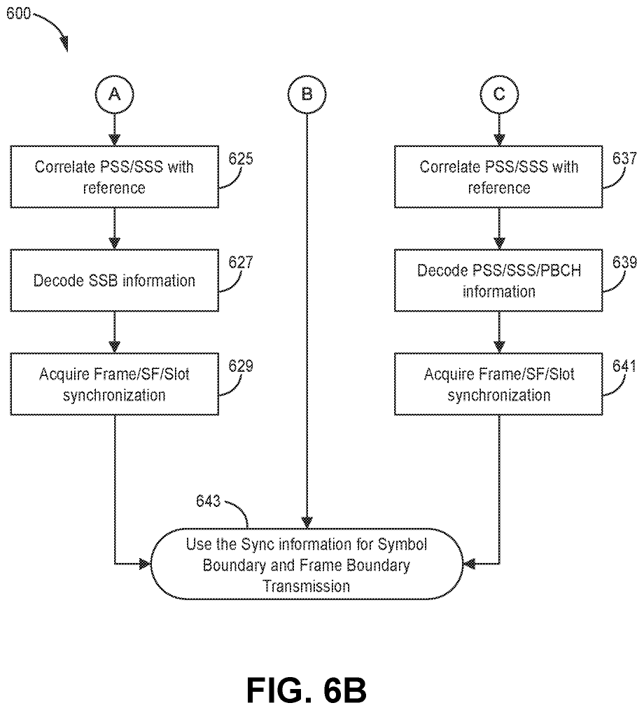

In the exemplary embodiment shown in FIGS. 1A-1C, each vMU 112 (and/or the associated VDIs 130) can also be configured to process the downlink user-plane and/or control-plane data for each donor base station 124 in order to determine timing and system information for the donor base station 124 and associated cell. This can involve processing the downlink user-plane and/or control-plane data for the donor base station 124 to perform the initial cell search processing a UE would typically perform in order to acquire time, frequency, and frame synchronization with the base station 124 and associated cell and to detect the Physical layer Cell ID (PCI) and other system information for the base station 124 and associated cell (for example, by detecting and/or decoding the Primary Synchronization Signal (PSS), the Secondary Synchronization Signal (SSS), the Physical Broadcast Channel (PBCH), the Master Information Block (MIB), and System Information Blocks (SIBs)). This timing and system information for a donor base station 124 can be used, for example, to configure the operation of the vDAS 100 (and the components thereof) in connection with serving that donor base station 124. For example, FIGS. 5, 6A, and 6B illustrate a method for acquiring the timing and system information for configuring the operation of the vDAS 100 based on identifying a system frame number and subframe number from a time and then identifying the system information using the identified system frame number and subframe number.

In order to reduce the latency associated with implementing each vMU 112 or ICN in a virtualized environment 108 running on a COTS physical server 104, input-output (IO) operations associated with communicating data between a vMU 112 and a physical donor interface 126 and/or between a vMU 112 and a physical transport interface 128, as well as any baseband processing performed by a vMU 112, associated VDI 130, or ICN 103 can be time-sliced to ensure that such operations are performed in a timely manner. With such an approach, the tasks and threads associated with such operations and processing are executed in dedicated time slices without such tasks and threads being preempted by, or otherwise having to wait for the completion of, other tasks or threads.

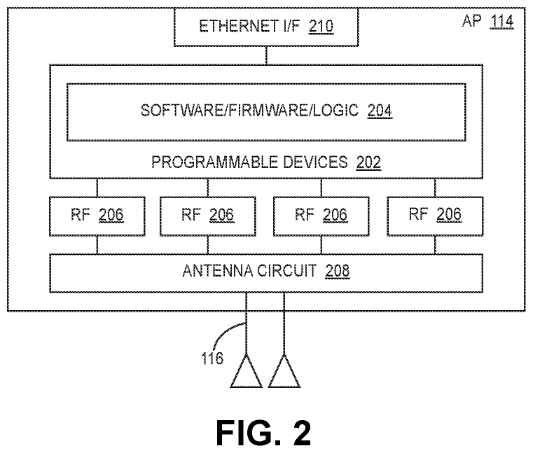

FIG. 2 is a block diagram illustrating one exemplary embodiment of an access point 114 that can be used in the vDAS 100 of FIGS. 1A-1C.

The AP 114 comprises one or more programmable devices 202 that execute, or are otherwise programmed or configured by, software, firmware, or configuration logic 204 in order to implement at least some functions described here as being performed by the AP 114 (including, for example, physical layer (Layer 1) baseband processing described here as being performed by a radio unit (RU) entity implemented using that AP 114). The one or more programmable devices 202 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way. In general, the programmable devices 202 and software, firmware, or configuration logic 204 are scaled so as to be able to implement multiple logical (or virtual) RU entities using the (physical) AP 114. The various functions described here as being performed by an RU entity are implemented by the programmable devices 202 and one or more of the RF modules 206 (described below) of the AP 114.

In general, each RU entity implemented by an AP 114 is associated with, and serves, one of the base stations 124 coupled to the vDAS 100. The RU entity communicates transport data with each vMU 112 serving that AP 114 using the particular fronthaul interface used for communicating over the fronthaul network 120 for the associated type of base station 124 and is configured to implement the associated fronthaul interface related processing (for example, formatting data in accordance with the fronthaul interface and implementing control-plane, management-plane, and synchronization-plane functions). The O-RAN fronthaul interface is used in some implementations of the exemplary embodiment described here in connection with FIGS. 1A-1C and 2. In addition, the RU entity performs any physical layer baseband processing that is required to be performed in the RU.

Normally, when a functional split 7-2 is used, some physical layer baseband processing is performed by the DU or BBU, and the remaining physical layer baseband processing and the RF functions are performed by the corresponding RU. The physical layer baseband processing performed by the DU or BBU is also referred to as the “high” physical layer baseband processing, and the baseband processing performed by the RU is also referred to as the “low” physical layer baseband processing.

As noted above, in some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user-plane data (and associated control-plane data), and the RU entity for that base station 124 performs the low physical layer baseband processing and the RF functions in addition to performing the processing related to communicating the transport data over the fronthaul network 120 of the vDAS 100. Where the associated base station 124 comprises a DU or BBU that is configured to use functional split 8 or where the associated base station 124 comprises a “complete” base station that is coupled to a vMU 112 using an analog RF interface, the transport data comprises time-domain user-plane data (and associated control-plane data) and the RU entity for that base station 124 performs the RF functions for the base station 124 in addition to performing the processing related to communicating the transport data over the fronthaul network 120 of the vDAS 100.

It is possible for a given AP 114 to communicate and process transport data for different base stations 124 served by that AP 114 in different ways. For example, a given AP 114 may serve a first base station 124 that uses functional split 7-2 and a second base station 124 that uses functional split 8, in which case the corresponding RU entity implemented in that AP 114 for the first base station 124 performs the low physical layer processing for the first base station 124 (including, for example, the inverse fast Fourier transform (iFFT) processing for the downlink data and the fast Fourier transform (FFT) processing for the uplink data), whereas the corresponding RU entity implemented in the AP 114 for the second base station 124 does not perform such low physical layer processing for the second base station 124.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user-plane data (and associated control-plane data), regardless of the functional split used by the associated base station 124. In such implementations, the vMU 112 converts the user-plane data as needed (for example, by converting the time-domain user-plane data to frequency-domain user-plane data and generating associated control-plane data).

In general, the physical layer baseband processing required to be performed by an RU entity for a given served base station 124 depends on the functional split used for the transport data.

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions), including filtering and combining.

In one exemplary implementation, the uplink RF analog signal (including the various physical channels and associated sub-carriers) received by each coverage antenna 116 is provided, via the antenna circuit 208, to an associated uplink signal path in each RF module 206.

Each uplink signal path in each RF module 206 receives the uplink RF analog signal received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filters and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ethernet link depending on how the fronthaul network 120 is implemented (more specifically, depending on whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the associated vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports of the base station 124. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated sub-carriers) output by the base station 124 and generate the downlink base station data by generating corresponding time-domain baseband in-phase and quadrature (IQ) data from the received download analog RF signals (for example, by performing an analog-to-digital (ADC) and digital down-conversion process on the received downlink analog RF signal). The generated downlink base station data is provided to the vMU 112 (for example, by communicating it over a PCIe lane to a CPU used to execute the vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to an RU. In this example, the physical donor interface 126 used to receive the one or more downlink base station signals comprises a physical CPRI donor interface 138. Each downlink CPRI fronthaul signal is received by a CPRI port of the physical CPRI donor interface 138 installed in the physical server computer 104 executing the vMU 112. The physical CPRI donor interface 138 is configured to receive each downlink CPRI fronthaul signal, generate downlink base station data by extracting various information flows that are multiplexed together in CPRI frames or messages that are communicated via the downlink CPRI fronthaul signal, and provide the generated downlink base station data to the vMU 112 (for example, by communicating it over a PCIe lane to a CPU used to execute the vMU 112). The extracted information flows can comprise CPRI user-plane data, CPRI control-and-management-plane data, and CPRI synchronization-plane data. That is, in this example, the downlink base station data comprises the various downlink information flows extracted from the downlink CPRI frames received via the downlink CPRI fronthaul signals. Alternatively, the downlink base station data can be generated by extracting downlink CPRI frames or messages from each received downlink CPRI fronthaul signal, where the extracted CPRI frames are provided to the vMU 112 (for example, by communicating them over a PCIe lane to a CPU used to execute the vMU 112).

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to an RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating them over a PCIe lane to a CPU used to execute the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 over the fronthaul network 120 to the set of APs 114 serving the base station 124. As described above, the downlink transport data for each base station 124 can be communicated to each AP 114 in the base station's simulcast zone via one or more intermediary units of the vDAS 100 (such as one or more ICNs or daisy-chained APs 114).

The downlink transport data generated for a base station 124 is communicated by the vMU 112 over the fronthaul network 120 so that downlink transport data for the base station 124 is received at the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation where the O-RAN fronthaul interface is used for the transport data, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114 or for it to be suitable for use with the fronthaul interface used for communicating over the fronthaul network 120 of the vDAS 100. For example, in one exemplary embodiment described here in connection with FIGS. 1A-1C and 2 where the vDAS 100 is configured to use an O-RAN fronthaul interface for communications between the vMU 112 and the APs 114, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100.

In those implementations where both the content of the transport data and the manner in which it is generated depend on the functional split and/or fronthaul interface used to couple the associated base station 124 to the vDAS 100, if the base station 124 comprises a DU or BBU that is coupled to the vDAS 100 using a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is coupled to the vDAS 100 using functional split 8 or where a base station 124 comprises a “complete” base station that is coupled to the vDAS 100 using an analog RF interface, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which it is generated is generally the same for all donor base stations 124, regardless of the functional split and/or fronthaul interface used to couple each donor base station 124 to the vDAS 100, all downlink transport data is generated in accordance with a functional split 7-2 where the corresponding user-plane data is communicated as frequency-domain user-plane data. For example, where a base station 124 comprises a DU or BBU that is coupled to the vDAS 100 using functional split 8 or where a base station 124 comprises a “complete” base station that is coupled to the vDAS 100 using an analog RF interface, the downlink base station data for the base station 124 comprises time-domain user-plane data for each antenna port of the base station 124 and the vMU 112 converts it to frequency-domain user-plane data and generates associated control-plane data in connection with generating the downlink transport data that is communicated between each vMU 112 and each AP 114 in the base station's simulcast zone. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with each such AP 114.

Where multicast addresses and/or VLANs are used for transmitting the downlink transport data to the APs 114 in a base station's simulcast zone, each AP 114 in the simulcast zone will receive the downlink transport data transmitted by the vMU 112 using that multicast address and/or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data, and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, an RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, an RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated sub-carriers) via the set of coverage antennas 116 associated with that AP 114, generates uplink transport data from the received uplink RF analog signals and communicates the uplink transport data from each AP 114 over the fronthaul network 120 of the vDAS 100. The uplink transport data is communicated over the fronthaul network 120 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receives uplink transport data derived from the uplink transport data transmitted from the APs 114 in the simulcast zone of the base station 124, generates uplink base station data from the received uplink transport data, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124. As described above, the uplink transport data can be communicated from the APs 114 in the simulcast zone of the base station 124 to the vMU 112 coupled to the base station 124 via one or more intermediary units of the vDAS 100 (such as one or more ICNs or daisy-chained APs 114).

As described above, a single set of uplink base station signals are produced for each donor base station 124 using a combining or summing process that uses inputs derived from the uplink RF signals received via the coverage antennas 116 associated with the multiple APs 114 in that base station's simulcast zone, where the resulting final single set of uplink base station signals is provided to the base station 124. Also, as noted above, this combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114).

How the corresponding user-plane data is combined or summed depends on the functional split used for communicating transport data between the vMUs 112 and the APs 114 and can be performed as described below in connection with FIG. 5.

The form that the uplink base station signals take and how the uplink base station signals are generated from the uplink base station data also depend on how the base station 124 is coupled to the vDAS 100.

For example, where an Ethernet-based fronthaul interface is used (such as O-RAN, eCPRI, or RoE) to couple the base station 124 to the vDAS 100, the vMU 112 is configured to format the uplink base station data into messages formatted in accordance with the associated Ethernet-based fronthaul interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, in one implementation, the uplink base station data comprises the various information flows that are multiplexed together in uplink CPRI frames or messages, and the vMU 112 is configured to generate these various information flows in accordance with the CPRI fronthaul interface. In such an implementation, the information flows are provided to the associated physical CPRI donor interface 138. The physical CPRI donor interface 138 uses these information flows to generate CPRI frames for communicating to the base station 124 via one or more CPRI ports of that physical CPRI donor interface 138. That is, in this example, the “uplink base station signals” comprise the physical-layer signals used to communicate such CPRI frames. Alternatively, in another implementation, the uplink base station data comprises CPRI frames or messages, which the VMU 112 is configured to produce and provide to the associated physical CPRI donor interface 138 for use in producing the physical-layer signals used to communicate the CPRI frames to the base station 124.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital up conversion and digital-to-analog (DAC) process). For each antenna port of the base station 124, the physical RF donor interface 134 outputs the respective uplink analog RF signal (including the various physical channels and associated sub-carriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN or TEN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 or ICN 103 because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways.

For example, FIGS. 3A-3D illustrate one such embodiment.

FIGS. 3A-3D are block diagrams illustrating one exemplary embodiment of vDAS 300 in which at least some of the APs 314 are coupled to one or more vMUs 112 serving them via one or more intermediate combining nodes (ICNs) 302. Each ICN 302 comprises at least one northbound Ethernet interface (NEI) 304 that couples the ICN 302 to Ethernet cabling used primarily for communicating with the one or more vMUs 112 and a plurality of southbound Ethernet interfaces (SEIs) 306 that couples the ICN 302 to Ethernet cabling used primarily for communicating with one or more of the plurality of APs 314.

Except as explicitly described here in connection with FIGS. 3A-3D, the vDAS 300 and the components thereof (including the vMU 112) are configured as described above. Also, except as explicitly described here in connection with FIGS. 3A-3D, each AP 314 is implemented in the same manner as the APs 114 described above.

The ICN 302 comprises one or more programmable devices 310 that execute, or are otherwise programmed or configured by, software, firmware, or configuration logic 312 in order to implement at least some of the functions described here as being performed by an ICN 302 (including, for example, any necessary physical layer (Layer 1) baseband processing). The one or more programmable devices 310 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The ICN 302 can be implemented as a physical network function using dedicated, special-purpose hardware. Alternatively, the ICN 302 can be implemented as a virtual network function running on a physical server. For example, the ICN 302 can be implemented in the same manner as the vMU 112 described above in connection with FIG. 1.

As noted above, the fronthaul network 320 used for transport between each vMU 112 and the APs 114 and ICNs 302 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each ICN 302 (and the APs 314 coupled thereto) to each vMU 112 serving that AP 114 or 314 or ICN 302.

In the example shown in FIG. 3B, the fronthaul network 320 is implemented using only point-to-point Ethernet links 123 or 323, where each AP 114 and each ICN 302 (and the APs 314 coupled thereto) is coupled to each serving vMU 112 serving it via a respective one or more point-to-point Ethernet links 123 or 323. In the example shown in FIG. 3C, the fronthaul network 320 is implemented using a combination of a switched Ethernet network 322 and point-to-point Ethernet links 123 or 323. In the example shown in FIG. 3D, a first ICN 302 has a second ICN 302 subtended from it so that some APs 314 are communicatively coupled to the first ICN 302 via the second ICN 302. Again, as noted above, it is to be understood that FIGS. 1A-1C and 3A-3D illustrate only a few examples of how the fronthaul network (and the vDAS more generally) can be implemented and that other variations are possible.

In one implementation, each vMU 112 that serves the ICN 302 treats the ICN 302 as one or more “virtual APs” to which it sends downlink transport data for one or more base stations 124, and from which it receives uplink transport data, for the one or more base stations 124. The ICN 302 forwards the downlink transport data to, and combines uplink transport data received from, one or more of the APs 314 coupled to the ICN 302. In one implementation of such an embodiment, the ICN 302 forwards the downlink transport data it receives for all the served base stations 124 to all of the APs 314 coupled to the ICN 302 and combines uplink transport data it receives from all of the APs 314 coupled to the ICN 302 for all of the base stations 124 served by the ICN 302.

In another implementation, the ICN 302 is configured so that a separate subset of the APs 314 coupled to that ICN 302 can be specified for each base station 124 served by that ICN 302. In such an implementation, for each base station 124 served by an ICN 302, the ICN 302 forwards the downlink transport data it receives for that base station 124 to the respective subset of the APs 314 specified for that base station 124 and combines the uplink transport data it receives from the subset of the APs 314 specified for that base station 124. That is, in this implementation, each ICN 302 can be used to forward the downlink transport data for different served base stations 124 to different subsets of APs 314 and to combine uplink transport data the ICN 302 receives from different subsets of APs 314 for different served base stations 124. Various techniques can be used to do this. For example, the ICN 302 can be configured to inspect one or more fields (or other parts) of the received transport data to identify which base station 124 the transport data is associated with. In another implementation, the ICN 302 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each ICN 302 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to an ICN 302 is configured to synchronize itself to the time base used in the rest of the vDAS 300 based on the synchronous Ethernet communications provided from the ICN 302.

In one example of the operation of the vDAS 300 of FIGS. 3A-3D, in the downlink direction, each ICN 302 receives downlink transport data for the base stations 124 served by that ICN 302 and communicates, using the southbound Ethernet interfaces 306 of the ICN 302, the downlink transport data to one or more of the APs 314 coupled to ICN 302. As noted above, in one implementation, each vMU 112 that is coupled to a base station 124 served by an ICN 302 treats the ICN 302 as a virtual AP and addresses downlink transport data for that base station 124 to the ICN 302, which receives it using the northbound Ethernet interface 304.

As noted above, for each served base station 124, the ICN 302 forwards the downlink transport data it receives from the serving vMU 112 for that base station 124 to one or more of the APs 314 coupled to the ICN 302. For example, as noted above, the ICN 302 can be configured to simply forward the downlink transport data it receives for all served base stations 124 to all of the APs 314 coupled to the ICN 302 or the ICN 302 can be configured so that a separate subset of the APs 314 coupled to the ICN 302 can be specified for each served base station 124, where the ICN 302 is configured to forward the downlink transport data it receives for each served base station 124 to only the specific subset of APs 314 specified for that base station 124.

Each AP 314 coupled to the ICN 302 receives the downlink transport data to it, generates respective sets of downlink analog RF signals for all base stations 124 served by the ICN 302, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the ICN 302 as described above. That is, how each AP 314 generates the set of downlink analog RF signals using the downlink transport data depends on the functional split used for communicating transport data between the vMUs 112, ICNs 302, and the APs 114 and 314. For example, where the downlink transport data comprises frequency-domain user-plane data and associated control-plane data for each antenna port of the base station 124, an RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, an RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the ICN 302 that is used to serve a base station 124 receives a respective set of uplink RF analog signals (including the various physical channels and associated sub-carriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, ICNs 302, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the ICN 302. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the ICN 302.

The ICN 302 receives respective uplink transport data transmitted from any subtended APs 314 or other ICNs 302. The respective uplink transport data transmitted from any subtended APs 314 and/or subtended ICNs 302 is received by the ICN 302 using the respective southbound Ethernet interfaces 306.

The ICN 302 extracts the respective uplink transport data for each served base station 124 and, for each served base station 124, combines or sums corresponding user-plane data included in the extracted uplink transport data received from the one or more subtended APs 314 and/or ICNs 302 coupled to that ICN 302 used to serve that base station 124. The manner in which each ICN 302 combines or sums the user-plane data depends on whether the user-plane data comprises time-domain data or frequency-domain data. Generally, the ICN 302 combines or sums the user-plane data in the same way that each vMU 112 does so (for example, as described below in connection with FIG. 5).

The ICN 302 generates uplink transport data for each served base station 124 that includes the respective combined user-plane data for that base station 124 and communicates the uplink transport data including combined user-plane data for each served base station 124 to the vMU 112 associated with that base station 124 or to an upstream ICN 302. In this exemplary embodiment described here in connection with FIGS. 3A-3D where the O-RAN fronthaul interface is used for communicating over the fronthaul network 120, each ICN 302 is configured to generate and format the uplink transport data in accordance with that O-RAN fronthaul interface.

The ICN 302 shown in FIGS. 3A-3D can be used to increase the number of APs 314 that can be served by each vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to by-pass the vMU 112.

Except as explicitly described here in connection with FIG. 4, the vDAS 400 and the components thereof are configured as described above.

In the exemplary embodiment shown in FIG. 4, the vDAS 400 includes at least one “by-pass” physical RF donor interface 434 that is configured to bypass the vMU 112 and instead, for the base stations 124 coupled to that physical RF donor interface 434, have that physical RF donor interface 434 perform at least some of the functions described above as being performed by the vMU 112. These functions include, for the downlink direction, receiving a set of downlink RF analog signals from each base station 124 coupled to the by-pass physical RF donor interface 434, generating downlink transport data from the set of downlink RF analog signals and communicating the downlink transport data to one or more of the APs or ICNs and, in the uplink direction, receiving respective uplink transport data from one or more APs or ICNs, generating a set of uplink RF analog signals from the received uplink transport data (including performing any digital combining or summing of user-plane data), and providing the uplink RF analog signals to the appropriate base stations 124. In this exemplary embodiment, each by-pass physical RF donor interface 434 includes one or more physical Ethernet transport interfaces 448 for communicating the transport data to and from the APs 114 and ICNs. The vDAS 400 (and the by-pass physical RF donor interface 434) can be used with any of the configurations described above (including, for example, those shown in FIGS. 1A-1C and FIGS. 3A-3D).

Each by-pass physical RF donor interface 434 comprises one or more programmable devices 450 that execute, or are otherwise programmed or configured by, software, firmware, or configuration logic 452 in order to implement at least some of the functions described here as being performed by the by-pass physical RF donor interface 434 (including, for example, any necessary physical layer (Layer 1) baseband processing). The one or more programmable devices 450 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The by-pass physical RF donor interface 434 can be used to reduce the overall latency associated with serving the base stations 124 coupled to that physical RF donor interface 434.

In one implementation, the by-pass physical RF donor interface 434 is configured to operate in a fully standalone mode in which the by-pass physical RF donor interface 434 performs substantially all “master unit” processing for the donor base stations 124 and APs and ICNs that it serves. For example, in such a fully standalone mode, in addition to the processing associated with generating and communicating user-plane and control-plane data over the fronthaul network 120, the by-pass physical RF donor interface 434 can also execute software that is configured to use a time synchronization protocol (for example, the IEEE 1588 PTP or SyncE protocol) to synchronize the by-pass physical RF donor interface 434 to a timing master entity established for the vDAS 100. In such a mode, the by-pass physical RF donor interface 434 can itself serve as a timing master for the APs and other nodes (for example, ICNs) served by that by-pass physical RF donor interface 434 or instead have another entity serve as a timing master for the APs and other nodes (for example, ICNs) served by that by-pass physical RF donor interface 434.

In such a fully standalone mode, the by-pass physical RF donor interface 434 can also execute software that is configured to process the downlink user-plane and/or control-plane data for each donor base station 124 in order to determine timing and system information for the donor base station 124 and associated cell (which, as described, can involve processing the downlink user-plane and/or control-plane data to perform the initial cell search processing a UE would typically perform in order to acquire time, frequency, and frame synchronization with the base station 124 and associated cell and to detect the PCI and other system information for the base station 124 and associated cell (for example, by detecting and/or decoding the PSS, the SSS, the PBCH, the MIB, and SIBs). This timing and system information for a donor base station 124 can be used, for example, to configure the operation of the by-pass physical RF donor interface 434 and/or the vDAS 100 (and the components thereof) in connection with serving that donor base station 124. In such a fully standalone mode, the by-pass physical RF donor interface 434 can also execute software that enables the by-pass physical RF donor interface 434 to exchange management-plane messages with the APs and other nodes (for example, ICNs) served by that by-pass physical RF donor interface 434 as well as with any external management entities coupled to it.

In other modes of operation, at least some of the “master unit” processing for the donor base stations 124 and APs and ICNs that the by-pass physical RF donor interface 434 serves are performed by a vMU 112. For example, the vMU 112 can serve as a timing master and the by-pass physical RF donor interface 434 can execute software that causes the by-pass physical RF donor interface 434 to serve as a timing sub-ordinate and exchange timing messages with the vMU 112 to enable the by-pass physical RF donor interface 434 to synchronize itself to the timing master. In such other modes, the by-pass physical RF donor interface 434 can itself serve as a timing master for the APs and other nodes (for example, ICNs) served by that by-pass physical RF donor interface 434 or instead have the vMU 112 (or other entity) serve as a timing master for the APs and other nodes (for example, ICNs) served by that by-pass physical RF donor interface 434. In such other modes, the vMU 112 can also execute software that is configured to process the downlink user-plane and/or control-plane data for each donor base station 124 served by the by-pass physical RF donor interface 434 in order to determine timing and system information for the donor base station 124 and associated cell. In connection with doing this, the by-pass physical RF donor interface 434 provides the required downlink user-plane and/or control-plane data to the vMU 112. In such other modes, the vMU 112 can also execute software that enables it to exchange management-plane messages with the by-pass physical RF donor interface 434 and the APs and other nodes (for example, ICNs) served by the by-pass physical RF donor interface 434 as well as with any external management entities coupled to it. In such other modes, data or messages can be communicated between the by-pass physical RF donor interface 434 and the vMU 112, for example, over the fronthaul switched Ethernet network 122 (which is suitable if the by-pass physical RF donor interface 434 is physically separate from the physical server computer 104 used to execute the vMU 112) or over a PCIe lane to a CPU used to execute the vMU 112 (which is suitable if the by-pass physical RF donor interface 434 is implemented as a card inserted into a slot of the physical server computer 104 used to execute the vMU 112).

The by-pass physical RF donor interface 434 can be configured and used in other ways.

As noted above, various entities in the vDAS 100, 300, or 400 combine or sum uplink data. For example, in the exemplary embodiment described above in connection with FIG. 1, as a part of generating the uplink base station data for each uplink antenna port of a base station 124, the corresponding vMU 112 combines or sums corresponding user-plane data included in the uplink transport data received from APs 114 in the base station's simulcast zone. In the exemplary embodiment described above in connection with FIG. 3, each ICN 302 also performs uplink combining or summing in the same general manner that the vMU 112 does. Also, in the exemplary embodiment described above in connection with FIG. 4, each physical donor RF interface 434 that is configured to by-pass the vMU 112 also performs uplink combining or summing in the same general manner that the vMU 112 does. Moreover, any daisy-chained also performs uplink combining or summing.

In the following description, an entity that is configured to perform uplink combining or summing is also referred to as a “combining entity,” and each entity that is subtended from a combining entity and that transmits uplink transport data to the combining entity is also referred to here as a “source entity” for that combining entity. That is, a distributed antenna system serving a base station can be considered to comprise at least one combining entity and a plurality of source entities communicatively coupled to the combining entity and configured to source uplink data for the base station to the combining entity. Also, the combining entity can be considered a source entity for itself in those situations where the combining entity is configured to receive uplink RF signals via coverage antennas 116 associated with it (for example, where the combining entity is a “daisy-chained” AP 114).

FIG. 5 is a block diagram illustrating different components of a DAS 500 that can identify a frame boundary as discussed according to certain embodiments described herein. As illustrated, the DAS 500 may be connected to a timing grandmaster 501 and a base station 503. The DAS 500 may include an RF donor card 505, a master unit 507, and a radio unit 509. The DAS 500 may function similarly to the vDAS 100, 300, or 400. The base station 503 may operate in a similar manner to one of the base stations 124 described above. The timing grandmaster 501 may refer to a source of timing information. The different components of the DAS 500 may be synchronized to the timing information provided by the timing grandmaster 501.

In some embodiments, the timing grandmaster 501 may be responsible for providing accurate timing synchronization signals to the other components of the DAS 500. The timing grandmaster 501 may communicate with the other components in the DAS 500 to synchronize the operation of the components in the DAS 500. The timing grandmaster 501 may include an accurate time source, or the timing grandmaster 501 may receive a timing signal from an external source. For example, the timing grandmaster 501 may provide synchronization signals to the base station 503 and components in the DAS 500, like the master unit 507 and radio unit 509. The synchronization signals may be PTP, NTP, or other types of signals used in a time synchronization protocol.

In certain embodiments, as the base station 503 and master unit 507 are synchronized to the timing grandmaster 501, the base station 503 and master unit 507 may be aware of the time of day. For example, the base station 503 and master unit 507 are synchronized to the timing grandmaster 501 to become aware of the time of day. When the base station 503 and master unit 507 are synchronized to the common time reference provided by the timing grandmaster 501, the master unit 507 may determine the time of day. From the determined time of day, the master unit 507 may determine the system frame number (SFN) and subframe number (SN) for communications received from the base station 503.

In exemplary embodiments, as the different components of the DAS 500 are synchronized to the timing grandmaster 501 and have determined the time of day, the different components may identify the SFN and the SN. For example, the messages received by the DAS may have a defined frame structure that includes a frame length and the number of frames within a time period. Thus, knowing the time of day, a component in the DAS 500 may calculate the time elapsed since the start of the day, and convert the elapsed time to a number of frames using the defined frame structure. As the component knows the number of frames, the component can identify the SFN and SN.

In some embodiments, knowing the SFN and SN simplifies the search for particular signals. For example, knowing the SFN and SN, a component can identify where the PBCH is present, as the PBCH is located in subframe 0. Thus, the component can go to a desired region in a received message and begin decoding the message. Thus, a master information block (MIB) and system information block (SIB) can be identified within the message and decoded in a straightforward manner without having to perform a channel raster to identify the channel having the primary synchronization signal (PSS), which can take a significant amount of time, impacting the ability of the DAS 500 to identify the frame boundary and begin the decoding of the message.

In other embodiments, some of the components of the DAS 500 are synchronized to the different timing sources. For example, the base station 503 and master unit 507 may be synchronized to the timing grandmaster 501. While the RF Donor card 505 may be synchronized to a different timing source, such as a GPS signal. When the components are synchronized to a different timing source, the difference between the different timing sources may be within an over-the-air time profile (for example, plus or minus three microseconds or other timing profiles). As the difference between the timing sources is within an OTA time profile, the symbols received through either the RF Donor card 505 or a digital signal received through the base station 503 are within a symbol period for the DAS 500.

In a further embodiment, when the DAS 500 implements a TDD system, the TDD may have a switch with a particular periodicity for the uplink and downlink. Different communication standards may allow for multiple combinations of the uplink and downlink periodicity. However, the base station 503 may support a limited number of potential permutations/combinations. As the master unit 507 is able to identify the frame boundary based on the time from the timing grandmaster 501, the master unit 507 may also analyze the received signals to determine which slots are downlink slots and uplink slots. For example, the slots can be compared to a predetermined lookup table of patterns, where some of the patterns are associated with uplinks and others associated with downlinks.

In additional embodiments, when the frame boundary is identified using the time of day, signals received from different sources may not be exactly aligned. In some implementations, the DAS 500 may perform a fine tune alignment to the frame boundary. For example, the RF donor card 505 and the master unit 507 may receive signals that are not exactly aligned but are within three microseconds of each other. Accordingly, the master unit 507 may perform a fine-tuning alignment to align the frame boundaries of the signals.

In some embodiments, the RF donor card 505 and the 507 may be separate components within the DAS 500 that are located within separate containers. When the RF donor card 505 and master unit 507 are located in separate containers, the RF donor card 505 and the master unit 507 may be connected to each other using ethernet connectivity. Further, when located in separated components, the RF donor card 505 may receive timing signals from the master unit 507. Further, the RF donor card 505 may provide time domain IQ signals to the master unit 507, which may perform switching and may acquire the configuration information, the master unit 507 may send the configuration information back to the RF donor card 505. When the RF donor card 505 is connected to the master unit 507 using ethernet connectivity, the ethernet packet jitter may be within a delta of three microseconds plus or minus the package jitter. In an alternative embodiment, the RF donor card 505 can be directly connected to the master unit 507 or integrated as part of the master unit 507. For example, the RF donor card 505 may connect to a card server in the master unit 507, where the RF donor card 505 is in a form factor that facilitates connection to the master unit 507. In some implementations, the RF donor card 505 may be in a small PCIA form factor for connection to the master unit 507.

The master unit 507 may synchronize with the base station 503 and decode information for configuring communications from the base station 503 through the 509. When the RF donor card 505 receives an RF signal from the base station 503, digitizes the signal, and provides the signal to the master unit 507 for decoding, the master unit 507 may provide the decoded information back to the RF donor card 505 to facilitate the operation of the RF donor card 505.

FIGS. 6A and 6B are flow diagrams of a method 600 for identifying the frame boundary according to some of the embodiments described herein. As shown, a timing grandmaster 601 provides a timing signal to both a base station 605 and to a master unit on the DAS (such as DAS 100, 300, 400, 500, as described above). The base station 605 may be similar to one of the base stations 124 and may communicate with the DAS through a digital or RF donor interface. For example, the base station 605 may provide an RF signal or a digital IQ signal. Further, the master unit may be similar to the master unit 507 or the vMU 112.

As illustrated, the method 600 proceeds at 603, where the SFN/SF/slot is calculated by the master unit from the timing information. For example, the master unit may identify the time of day from the timing information and then, with knowledge of the frame structure, determine the system frame number, subframe number, and slot information. Also, when the base station 605 provides a signal to the DAS, the method 600 may proceed at 607, where the master unit determines the input type of the signal from the DAS. For example, the master unit may determine whether the signal is a digital IQ signal or an RF signal.

In certain embodiments, when the master unit determines that the signal is an RF signal, the method 600 proceeds to a method performed on the RF donor card 609. As shown, the method 600 proceeds at 611, where the RF donor card 609 iterates through N different communication channels. For each channel in the N channels, the method 600 proceeds at 613, where the RF donor card 609 scans a raster for a particular channel. For example, the RF donor card 609 may divide the frequency range of the channel into smaller frequency subdivisions and then scan each of the smaller subdivisions. For example, the RF donor card 609 may separate the frequency range of the channel into 100 KHz subdivisions. Further, when scanning a particular subdivision within the channel, the RF donor card 609 determines if any signals in the subdivision are substantially high enough to indicate that a signal is being received on the frequency subdivision at the specific channel. When the RF donor card 609 identifies the frequency at the specific channel, the RF donor card 609 converts the received RF signal to a digital IQ signal. Further, the method proceeds at 617, where the 609 provides the converted digital IQ to the master unit, where the master unit stores the converted digital IQ.

In further embodiments, returning to 607, when the master unit determines that the received signal is a digital IQ signal, the method 600 proceeds to 617, where the master unit stores the received digital IQ signal. Further, at 617, the master unit uses the calculated SFN/SF and slot info that was calculated based on the timing from the timing grandmaster 601.

In certain embodiments, when the master unit receives an ORAN signal, the master unit may already know the symbol number and frame number. In particular, an IQ symbol provided by the base station 605 may have a particular symbol number provided with the IQ symbol. For example, the control plane information provided by the base station 605 includes the SFN and SN. Thus, an ORAN master unit can use the provided SFN and SN to align their system, and decode the desired information. In some embodiments, when the master unit is an ORAN master unit, the master unit may still acquire the time of day based on the time provided by the grandmaster 601.

In exemplary embodiments, the master unit may receive 4G and 5G signals. When the master unit receives 5G signals, the method 600 proceeds at 619, where the master unit determines whether an SFN, SN, or slot is a 5G synchronization signal block (SSB) occurrence. In 5G, synchronization signals are not located at a fixed location in the carrier bandwidth. Thus, the master unit may determine whether the SFN, SN, and slot match a potential SSB location. If the SFN, SN, and slot do not match a potential SSB location, the master unit goes to the next potential slot for processing. If the slot does match a potential SSB location, the method 600 proceeds at 621, where the master unit checks for signal power in the primary synchronization signal (PSS) and the secondary synchronization signal (SSS). The method 600 then proceeds to 623, where the master unit determines if the checked signal power is greater than a threshold power. If the power is greater than the power threshold, the method 600 proceeds at 625 (shown in FIG. 6B, where the information in the SSB is correlated with reference data. For example, the master unit may correlate the detected SSB with predefined reference data for the PSS and SSS, which allows the master unit to acquire information about the communications from the base station.

In certain embodiments, after correlating the PSS and SSS in the detected SSB with the reference data, the method 600 proceeds at 627, where the master unit decodes the information in the SSB. The master unit may decode information that facilitates synchronization with the base station 605. For example, the master unit may synchronize with the base station 605 to identify the MIB and SIB. Also, the master unit may decode information in the SSS and PSS. In some embodiments, the decoded information may include the following information shown in Table 1:

TABLE 1

short systemFrameNumber,
short k_SSB,
short SSB_SCS,
float pbchBer,
float pbchEvm,
short controlResourceSetZero,
short searchSpaceZero,
short ssbPeriodicity,
short CarrierBw,
short PointA,
short offsetToCarrier,
short OffsettoPointA,
int absoluteFrequency,
short dlulPeriodicity”,
short nrofDownlinkSlots,
short nrofDownlinkSymbols,
short nrofUplinkSlots,
short nrofUplinkSymbols,

When the master unit decodes the SSB, the method 600 proceeds at 629, where the master unit acquires frame, subframe, and slot synchronization with the base station 605. When the master unit is synchronized with the base station 605, the method 600 may proceed at 643, where the master unit can use the synchronization information to identify the symbol boundary and frame boundary for transmission.

Returning to FIG. 6A, when the master unit receives a 4G signal, the method 600 proceeds at 631, where the master unit determines whether an SFN, SN, or slot is a 4G synchronization signal block (SSB) occurrence. In 4G, the synchronization signals are located at a fixed location in the carrier bandwidth. Thus, the master unit may use the SFN and SN to look for the PSS and SSS in the appropriate location. If the PBCH is located at the appropriate location, the SFN and SN are associated with a valid cell, and the method 600 proceeds at 633, where the master unit checks for signal power in the PSS and the SSS. The method 600 then proceeds to 635, where the master unit determines if the checked signal power is greater than a threshold power. If the power is greater than the power threshold, the method 600 proceeds at 625 (shown in FIG. 6B), where the information in the PSS and SSS are correlated with reference data. For example, the master unit may correlate the detected PSS and SSS with predefined reference data for the PSS and SSS that allows the master unit to acquire information about the communications from the base station.

In certain embodiments, after correlating the PSS and SSS in the detected SSB with the reference data, the method 600 proceeds at 639, where the master unit decodes the information in the SSB. The master unit may decode information that facilitates synchronization with the base station 605. For example, the master unit may synchronize with the base station 605 to identify the MIB and SIB. Also, the master unit may decode information in the SSS and PSS. In some embodiments, the decoded information may include the information shown above in Table 1. When the master unit decodes the SSB, the method 600 proceeds at 629, where the master unit acquires frame, subframe, and slot synchronization with the base station 605. When the master unit is synchronized with the base station 605, the method 600 may proceed at 643, where the master unit can use the synchronization information to identify the symbol boundary and frame boundary for transmission. The master unit may provide the frame boundaries to any connected access points.

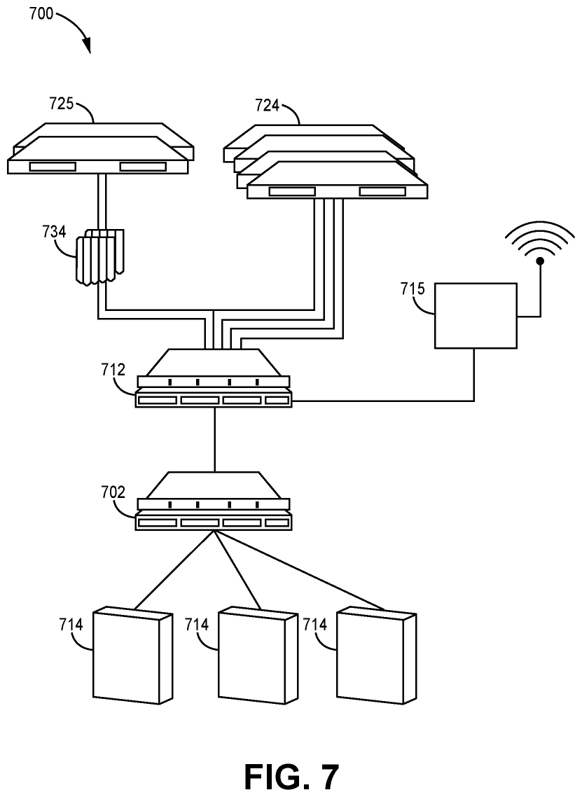

FIG. 7 is a block diagram of a system 700 that includes a DAS that functions substantially as described above with relation to DAS 100, 300, and 400 as described above or other similar systems. As shown, the system 700 may include a master unit 712. The master unit 712 may function similar to the vMU 112 described above in relation to the DAS 100, 300, and 400 described above. As such, the master unit 712 may be implemented by a physical server 104 as described above or as a standalone dedicated device.

As illustrated, the master unit 712 may receive signals from multiple sources that provide different signal types. For example, the master unit 712 may receive radio frames from one or more RF sources 725 and/or from one or more packet-based sources 724. The RF sources and packet-based sources 724 are substantially described above in relation to base stations 124 that provide radio frames through the ethernet donor interface 142, the CPRI donor interface 138, or the RF donor interface 134. Additionally, the radio frames received by the master unit 712 may have different timings. For example, where one or more packet-based sources 724 are O-RAN sources, the packet-based sources may provide frequency-domain IQ data having meaningful jitter between the packets. As such, radio frames received from the sources 724 may be synchronized using a protocol such as NTP or PTP. However, other sources (like one of the RF sources 725 or where one of the packet-based sources 724 is a CPRI source) may provide time-domain IQ data as a synchronous stream of IQ data, where signals can be synchronized using a protocol like SyncE. In some embodiments, the master unit 712 also receives timing information, such as that received from a PTP grandmaster 715, where the PTP grandmaster 715 functions as a timing reference. The PTP grandmaster 715 may also be a timing reference that provides timing according to a protocol other than PTP and the PTP grandmaster 715 is also referred to herein as timing reference 715.

In additional embodiments, the master unit 712 may provide the received signals from the different sources to an ICN 702 or to the APs 714. The ICN 702 may function substantially similar to the ICNs 302 described above and the APs 714 may function substantially similar to the APs 114 described above. As the APs 714 transmit signals to the UEs 118 as described above, to facilitate the transmission of the signals from an AP 714, the AP 714 may align the signals with a single OTA time offset. However, the signals received for transmission by an AP 714 may have different timing profiles. Accordingly, the AP 714 may be able to align signals from sources having different timing profiles with a common frame boundary.

In certain embodiments, an AP 714 may identify a common frame boundary based on the timing of fronthaul data received from one or more packet-based sources 724 with respect to the timing reference 715. For example, the AP 714 may select the data from one of the packet-based sources 724 and synchronize data received from other sources with the frame boundaries of the selected packet-based source 724. When selecting the data from a packet-based source 724 to act as the frame boundary, the AP 714 may select the frame boundary for data from a packet-based source 724 that is received first. Alternatively, the AP 714 may select a common frame boundary based on a median frame boundary, average frame boundary, or other method for determining a frame boundary based on unsynchronized data received from multiple packet-based sources 724. When the AP 714 identifies the common frame boundary, the AP 714 may align the transmission of OTA frames, subframes, slots, and symbols from the different packet-based sources 724 to the common frame boundary.

In some embodiments, where an AP 714 receives data from an RF Source 725 in addition to the packet-based sources 724, the AP 714 may select the frame boundary for the data from the RF source 725 as the common frame boundary. After selecting the frame boundary for the RF source as the common frame boundary, the AP 714 may align the OTA frames, subframes, slots, and symbols from the other non-RF packet-based sources 724 to the common frame boundary. That is, transmission from an AP 714 of OTA frames, subframes, slots, and symbols from the different sources are aligned to the common frame boundary.

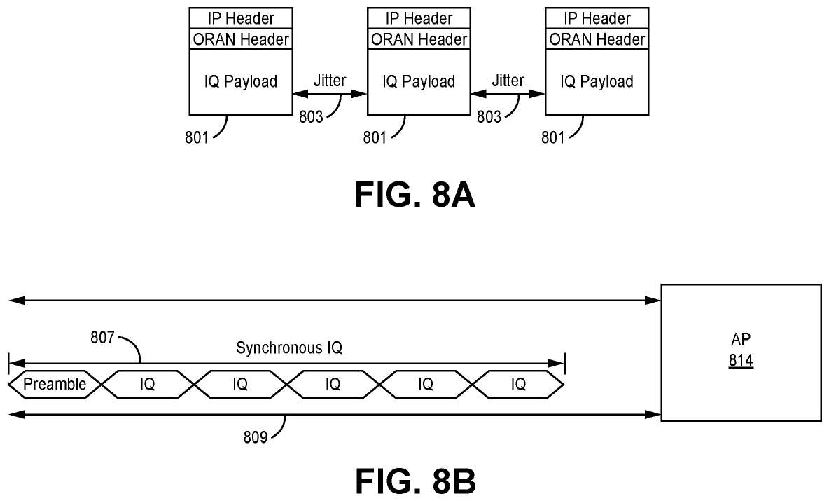

FIGS. 8A and 8B illustrates different diagrams of various timing formats potentially received from different sources. For example, FIG. 8A illustrates various packets transmitted from a packet-based source that may use a packet-based timing protocol, (such as PTP or NTP. The packet-based source may be an ORAN source. For example, a packet-based source may transmit multiple packets 801 that are separated by a jitter 803. As illustrated, each packet 801 may include an IP header, an ORAN header, and an IQ payload, thought the packets 801 may have different data structures.

FIG. 8B illustrates frames transmitted from a source using a synchronous IQ transmission 809 to an AP 714. For example, the synchronous transmission 809 may comprise multiple IQ frames 807. The synchronous IQ transmission may be transmitted as part of a SyncE transmission, a CPRI transmission, an RF transmission etc. In some embodiments, the AP 514 may align the packet based IQ data illustrated in the FIG. 8A with the frame boundaries of the synchronous transmission 809.

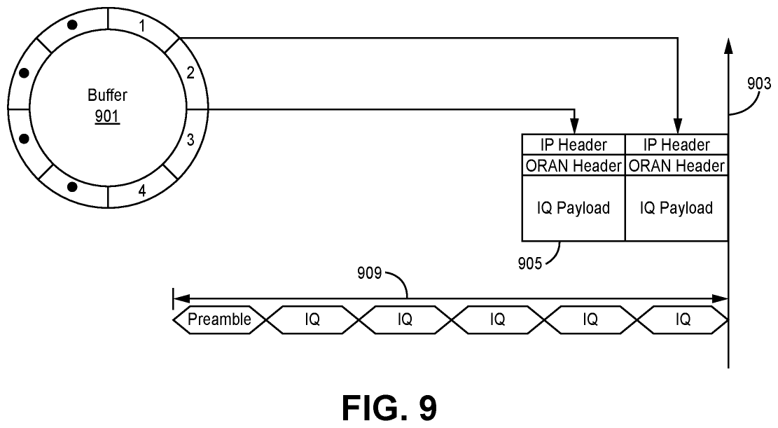

FIG. 9 is a diagram illustrating the use of a buffer 901 for aligning received data with a common frame boundary 903. As illustrated, the buffer 901 is a circular buffer, though other data structures may be employed to provide similar functionality as described herein. As described above, the AP 714 may identify a common frame boundary based on the timing of the data received from multiple sources having different timing protocols. For example, the AP 714 may receive packet based data 905 from packet-based sources or from synchronous sources. If the AP 714 receives the packet based data 905 from packet-based sources, the AP 714 selects a common frame boundary from the frame boundary for packets from one of the packet-based sources, or from an average of the frame boundaries for the different packet-based sources. If the AP 714 receives synchronous data 907, the AP 714 may select the start of the frames for one of the synchronous data streams as the common frame boundary 903.

When the AP 714 aligns different packet-based data streams to the common frame boundary, the AP 714 may store the packets as they are received within a buffer 901. To implement the buffer 901, packets from a packet-based source are stored in the circular buffer 901 in the order that they are received. As shown, IQ symbols 1-4 are stored in the buffer 901 in the order that they are received. To transmit the IQ symbols, the AP 714 may pull the packet that was stored first from the buffer 901 and align the transmission of the packet with the common frame boundary 903. The AP 714 may maintain multiple circular buffers 901, where each circular buffer is associated with a different packet-based source. As the synchronous data 907 and the packet based data 905 are aligned with the common frame boundary 903, the AP 714 transmits the frames at the same OTA frame boundary.

In certain embodiments, a non-RF data source may receive information related to the delay caused by the implementation of the buffer 901 or by the aligning of data with a common frame boundary 903 from the DAS and/or access points. Some data sources that receive delay information may learn and compensate for the timing delays communicated from the DAS and/or access points. Accordingly, some packet-based sources may adjust the transmission of the packet-based data 905 to more closely align with the common frame boundary 903.

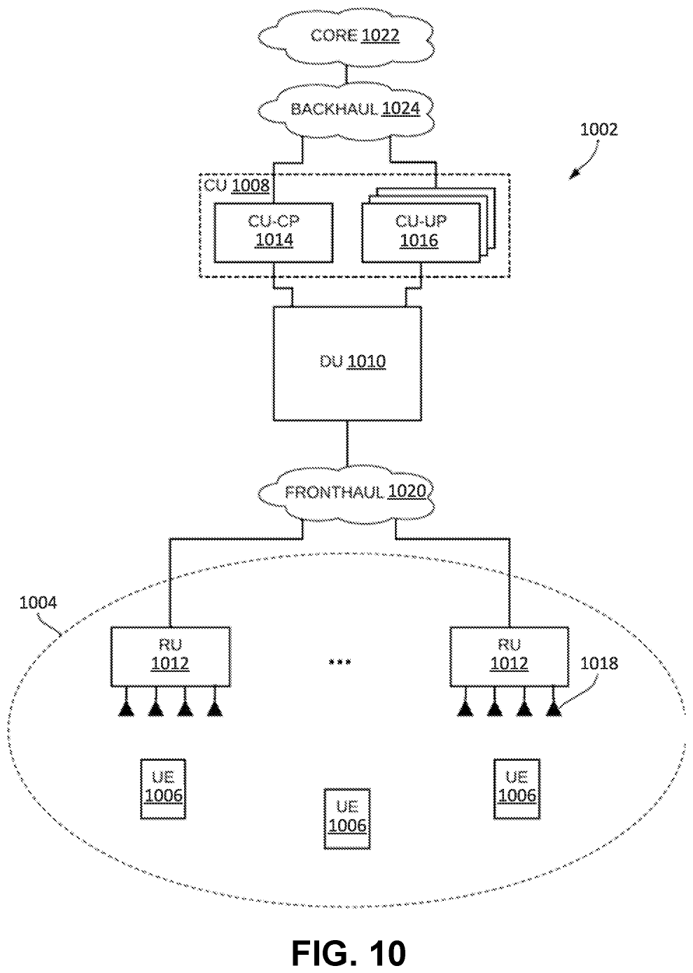

FIG. 10 is a block diagram illustrating one exemplary embodiment of a radio access network (RAN) system 1000 in which the slot-by-slot power saving techniques described above can be used.

The system 1000 shown in FIG. 10 implements at least one base station entity 1002 to serve a cell 1004. Each such base station entity 1002 can also be referred to here as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

In general, each base station 1002 is configured to provide wireless service to various items of user equipment (UEs) 1006 served by the associated cell 1004. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with UEs 1006. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In the specific exemplary embodiment shown in FIG. 10, each base station 1002 is implemented as a respective 5G NR gNB 1002 (only one of which is shown in FIG. 10 for ease of illustration). In this embodiment, each gNB 1002 is partitioned into one or more central unit entities (CUs) 1008, one or more distributed unit entities (DUs) 1010, and one or more radio units (RUs) 1012. In such a configuration, each CU 1008 implements Layer 3 and non-time critical Layer 2 functions for the gNB 1002. In the embodiment shown in FIG. 10, each CU 1008 is further partitioned into one or more control-plane entities 1014 and one or more user-plane entities 1016 that handle the control-plane and user-plane processing of the CU 1008, respectively. Each such control-plane CU entity 1014 is also referred to as a “CU-CP” 1014, and each such user-plane CU entity 1016 is also referred to as a “CU-UP” 1016. Also, in such a configuration, each DU 1010 is configured to implement the time critical Layer 2 functions and, except as described below, at least some of the Layer 1 functions for the gNB 1002. In this example, each RU 1012 is configured to implement the physical layer functions for the gNB 1002 that are not implemented in the DU 1010 as well as the RF interface. Also, each RU 1012 includes or is coupled to a respective set of one or more antennas 1018 via which downlink RF signals are radiated to UEs 1006 and via which uplink RF signals transmitted by UEs 1006 are received.

In one implementation (shown in FIG. 10), each RU 1012 is remotely located from each DU 1010 serving it. Also, in such an implementation, at least one of the RUs 1012 is remotely located from at least one other RU 1012 serving the associated cell 1004. In another implementation, at least some of the RUs 1012 are co-located with each other, where the respective sets of antennas 1018 associated with the RUs 1012 are directed to transmit and receive signals from different areas. Moreover, in the implementation shown in FIG. 10, the gNB 1002 includes multiple RUs 1012 to serve a single cell 1004; however, it is to be understood that gNB 1002 can include only a single RU 1012 to serve a cell 1004.

Each RU 1012 is communicatively coupled to the DU 1010 serving it via a fronthaul network 1020. The fronthaul network 1020 can be implemented using a switched Ethernet network, in which case each RU 1012 and each physical node on which each DU 1010 is implemented includes one or more Ethernet network interfaces to couple each RU 1012 and each DU physical node to the fronthaul network 1020 in order to facilitate communications between the DU 1010 and the RUs 1012. In one implementation, the fronthaul interface promulgated by the O-RAN Alliance is used for communication between the DU 1010 and the RUs 1012 over the fronthaul network 1020. In another implementation, a proprietary fronthaul interface that uses a so-called “functional split 7-2” for at least some of the physical channels (for example, for the PDSCH and PUSCH) and a different functional split for at least some of the other physical channels (for example, using a functional split 6 for the PRACH and SRS). The RUs 1012 may acquire the OTA frame boundary timing from data received through the fronthaul network 1020. Additionally, in identifying the common OTA frame boundary from the data received through the fronthaul network 1020 in a similar manner as described above with respect to the APs 714.

In such an example, each CU 1008 is configured to communicate with a core network 1022 of the associated wireless operator using an appropriate backhaul network 1024 (typically, a public wide area network such as the Internet).

Although FIG. 10 (and the description set forth below more generally) is described in the context of a 5G embodiment in which each logical base station entity 1002 is partitioned into a CU 1008, DUs 1010, and RUs 1012 and, for at least some of the physical channels, some physical-layer processing is performed in the DUs 1010 with the remaining physical-layer processing being performed in the RUs 1012, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 1008, DU 1010, and RU 1012, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 1008, DU 1010, and RU 1012, can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 10, each RU 1012 is implemented as a PNF and is deployed in or near a physical location where radio coverage is to be provided and each CU 1006 and DU 1008 is implemented using a respective set of one or more VNFs deployed in a distributed manner within one or more clouds (for example, within an “edge” cloud or “central” cloud).

Each CU 1008, DU 1010, and RU 1012, and any of the specific features described here as being implemented thereby, can be implemented in other ways.

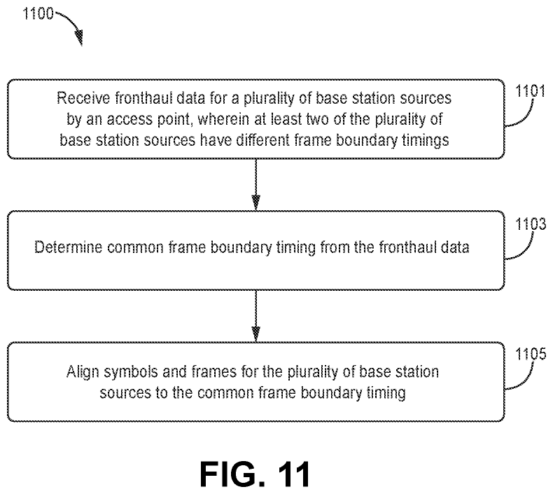

FIG. 11 is a flowchart diagram of a method 1100 for identifying a common frame boundary timing as described above. As illustrated, the method 1100 proceeds at 1101, where fronthaul data is received for a plurality of base station sources by an access point, wherein at least two of the plurality of base station sources have different frame boundary timings. For example, the API can receive frames from an ORAN source, a CPRI source, an RF source, or other type of source, where the different sources have different frame timings. The Method 1100 then proceeds at 1103, where a common frame boundary timing is determined from the fronthaul data. For example, an AP may determine that the frame boundary timing for data from a packet-based source should be used for the common frame boundary timing. Alternatively, the AP may determine that the frame boundary timing for data from an RF source should be used for the common frame boundary timing.

Further, the method 1100 proceeds at 1105, where symbols and frames for the plurality of base station sources are aligned to the common frame boundary timing. For example, the AP may use one or more buffers for storing symbols and frames from a data source. The AP may then take a frame from the buffer for transmission at the common frame boundary timing. Additionally, where possible, the master unit associated with the AP may communicate information regarding the delay from using a buffer to the source that provided the symbols and frames stored in the buffer.

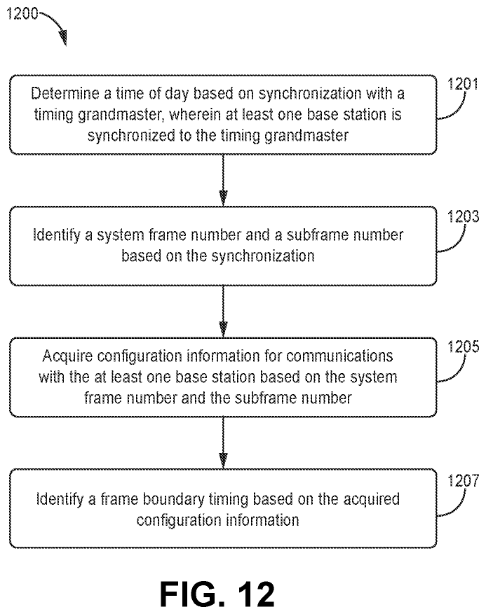

FIG. 12 is a flowchart diagram of a method 1200 for synchronizing a distributed antenna system with a base station as described above. As illustrated, the method 1200 proceeds at 1201, where a time of day is determined based on synchronization with a timing grandmaster, wherein at least one base station is synchronized to the timing grandmaster. Further, the method 1200 proceeds at 1203, where a system frame number and a subframe number are identified based on the synchronization. Also, the method 1200 proceeds at 1205, where configuration information is acquired for communications with the at least one base station based on the system frame number and the subframe number. Moreover, the method 1200 proceeds at 1207, where a frame boundary is identified based on the acquired configuration information.

### EXAMPLE EMBODIMENTS

Example 1 includes a distributed antenna system (DAS) comprising: a master unit coupled to a first base station source and a second base station source, the first base station source having OTA frame boundary timing that differs from the second base station source; and at least one access point coupled to the master unit, the at least one access point configured to: receive fronthaul data for both the first base station source and the second base station source; determine a common OTA frame boundary timing; and align OTA symbols and frames for the first base station source and the second base station source to the common OTA frame boundary timing.

Example 2 includes the DAS of Example 1, wherein the first base station source comprises an RF source and the second base station source comprises an O-RAN source.

Example 3 includes the DAS of Example 2, wherein the at least one access point determines the common OTA frame boundary timing based on fronthaul data received from the RF source.

Example 4 includes the DAS of any of Examples 1-3, wherein the first base station source comprises a packet-based source and the second base station source comprises a packet-based source.

Example 5 includes the DAS of Example 4, wherein the at least one access point selects the common OTA frame boundary timing based on at least one of: frame boundary timing of packets received from one of the first base station source and the second base station source; and a combination of the frame boundary timing of the packets received from both the first base station source and the second base station source.

Example 6 includes the DAS of any of Examples 1-5, wherein the at least one access point uses a buffer to align the OTA symbols and frames for at least one of the first base station source and the second base station source to the common OTA frame boundary timing.

Example 7 includes the DAS of Example 6, wherein the buffer is a circular buffer and the at least one access point stores frames from a packet-based source in the circular buffer for aligning with the common OTA frame boundary timing.

Example 8 includes the DAS of any of Examples 6-7, wherein the master unit provides delay information to one of the first base station source or the second base station source, wherein the delay information describes a delay caused by using the buffer to align the OTA symbols and frames.

Example 9 includes the DAS of any of Examples 1-8, wherein determining the common OTA frame boundary timing comprises receiving a frame boundary timing for the first base station source from the master unit, wherein when the master unit determines the frame boundary timing for the first base station, the master unit is configured to: synchronize to a timing signal from a timing grandmaster, wherein the first base station source is synchronized to the timing grandmaster; identify a system frame number and a subframe number based on a time of day calculated from the timing signal; acquire configuration information for communications with the first base station source based on the system frame number and the subframe number; and identify the frame boundary timing based on the acquired configuration information.

Example 10 includes the DAS of Example 9, wherein the master unit synchronizes to the timing signal using precision timing protocol.

Example 11 includes the DAS of any of Examples 9-10, wherein the master unit acquires the configuration information by: receiving signals from the first base station source, identifying synchronization blocks in the received signals based on the system frame number and the subframe number; and decoding the configuration information from the received signals.

Example 12 includes the DAS of Example 11, wherein the master unit identifies the synchronization blocks by: finding a location for the synchronization blocks based on the system frame number and the subframe number; checking if the location contains the synchronization blocks; determining if the location has a signal above a power threshold; and correlating the signal at the location with a synchronization reference.

Example 13 includes the DAS of any of Examples 9-12, wherein when the first base station is an RF source, an RF donor card receives an RF signal from the first base station source.

Example 14 includes the DAS of Example 13, wherein the RF donor card is configured to: identify a center frequency and channel for the RF signal by determining a power level of the RF signal over a channel raster for different communication channels, convert the RF signal to a digital signal; and provide the digital signal to the master unit.

Example 15 includes the DAS of any of Examples 13-14, wherein the master unit provides the configuration information to the RF donor card.

Example 16 includes the DAS of any of Examples 13-15, wherein the RF donor card is at least one of: mounted within a separate container from the master unit; and directly connected to the master unit.

Example 17 includes the DAS of any of Examples 9-16, wherein the master unit aligns received signals to the frame boundary timing.

Example 18 includes the DAS of any of Examples 9-17, wherein the master unit is part of a time division duplexing system and the master unit identifies uplink periodicity and downlink periodicity based on the system frame number and the subframe number.

Example 19 includes a radio access network (RAN) comprising: a plurality of base station sources, wherein at least two base station sources in the plurality of base station sources have different OTA frame boundary timing; and at least one radio unit coupled to the plurality of base station sources, the at least one radio unit configured to: receive fronthaul data for the plurality of base station sources; determine common OTA frame boundary timing; and align OTA symbols and frames for the plurality of base station sources to the common OTA frame boundary timing.

Example 20 includes the RAN of Example 19, wherein the at least one radio unit uses a buffer to align the OTA symbols and frames for the plurality of base station sources to the common OTA frame boundary timing.

Example 21 includes the RAN of Example 20, wherein the buffer is a circular buffer and the at least one radio unit stores frames from a packet-based source in the circular buffer for aligning with the common OTA frame boundary timing.

Example 22 includes the RAN of any of Examples 19-21, wherein the at least two base station sources comprise an RF source and an O-RAN source.

Example 23 includes the RAN of Example 22, wherein the at least one radio unit determines the common OTA frame boundary timing based on the fronthaul data received from the RF source.

Example 24 includes the RAN of any of Examples 19-23, wherein the at least two base station sources comprise packet-based sources.

Example 25 includes the RAN of Example 24, wherein the at least one radio unit selects the common OTA frame boundary timing based on at least one of: frame boundary timing of packets received from one of the at least two base station sources; and a combination of the frame boundary timing of packets received from the at least two base station sources.

Example 26 includes a method comprising: receiving fronthaul data for a plurality of base station sources by an access point, wherein at least two of the plurality of base station sources have different frame boundary timings; determining common frame boundary timing from the fronthaul data; and aligning symbols and frames for the plurality of base station sources to the common frame boundary timing.

Example 27 includes the method of Example 26, further comprising using a circular buffer to align the symbols and frames from a packet-based source in the plurality of base station sources to the common frame boundary timing.

Example 28 includes the method of any of Examples 26-27, further comprising, wherein the plurality of base station sources comprise an RF source and an O-RAN source, determining the common frame boundary timing based on the fronthaul data from the RF source.

Example 29 includes the method of any of Examples 26-28, further comprising, wherein the at least two base station sources comprise packet-based sources, selecting the common frame boundary timing based on at least one of: frame boundary timing of packets received from one of the at least two base station sources; and a combination of the frame boundary timing of packets received from the at least two base station sources.

Example 30 includes the method of any of Examples 26-29, further comprising providing delay information to one of the plurality of base station sources, wherein the delay information describes a delay caused by using a buffer to align the symbols and frames.

Example 31 includes a system, comprising: a timing grandmaster; at least one base station that is synchronized with the timing grandmaster; and a master unit coupled to the at least one base station, wherein the master unit is synchronized with the timing grandmaster, wherein the master unit is configured to: determine the time of day based on the synchronization with the timing grandmaster; identify a system frame number and a subframe number based on the time of day; acquire configuration information for communications with the at least one base station based on the system frame number and the subframe number; and identify frame boundary timing based on the acquired configuration information.

Example 32 includes the system of Example 31, wherein the master unit acquires the configuration information by: receiving signals from the at least one base station, identifying synchronization blocks in the received signals based on the system frame number and the subframe number; and decoding the configuration information from the received signals.

Example 33 includes the system of Example 32, wherein the master unit identifies the synchronization blocks by: finding a location for the synchronization blocks based on the system frame number and the subframe number; checking if the location contains the synchronization blocks; determining if the location has a signal above a power threshold; and correlating the signal at the location with a synchronization reference.

Example 34 includes the system of any of Examples 31-33, further comprising an RF donor card, wherein when the RF donor card receives an RF signal from the at least one base station when the at least one base station is an RF source.

Example 35 includes the system of Example 34, wherein the RF donor card is configured to: identify a center frequency and channel for the RF signal by determining a power level of the RF signal over a channel raster for different communication channels, convert the RF signal to a digital signal; and provide the digital signal to the master unit.

Example 36 includes the system of any of Examples 31-35, wherein the at least one base station is an ORAN base station and the master unit identifies the system frame number and the subframe number in signals received from the at least one base station.

Example 37 includes the system of any of Examples 31-36, wherein the master unit aligns received signals to the frame boundary timing.

Example 38 includes the system of any of Examples 31-37, wherein the master unit is part of a time division duplexing system and the master unit identifies uplink periodicity and downlink periodicity based on the system frame number and the subframe number.

Example 39 includes the system of any of Examples 31-38, wherein the master unit provides the frame boundary timing to an access point, wherein the access point uses the frame boundary timing as a common OTA frame boundary timing.

Example 40 includes a method comprising: determining a time of day based on synchronization with a timing grandmaster, wherein at least one base station is synchronized to the timing grandmaster; identifying a system frame number and a subframe number based on the synchronization; acquiring configuration information for communications with the at least one base station based on the system frame number and the subframe number; and identifying a frame boundary timing based on the acquired configuration information.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A distributed antenna system (DAS) comprising:
a master unit coupled to a first base station source and a second base station source, the first base station source having OTA frame boundary timing that differs from the second base station source; and
at least one access point coupled to the master unit, the at least one access point configured to:
receive fronthaul data for both the first base station source and the second base station source;
determine a common OTA frame boundary timing; and
align OTA symbols and frames for the first base station source and the second base station source to the common OTA frame boundary timing.

2. The DAS of claim 1, wherein the first base station source comprises an RF source and the second base station source comprises an O-RAN source.

3. The DAS of claim 2, wherein the at least one access point determines the common OTA frame boundary timing based on fronthaul data received from the RF source.

4. The DAS of claim 1, wherein the first base station source comprises a packet-based source and the second base station source comprises a packet-based source.

5. The DAS of claim 4, wherein the at least one access point selects the common OTA frame boundary timing based on at least one of:
frame boundary timing of packets received from one of the first base station source and the second base station source; and
a combination of the frame boundary timing of the packets received from both the first base station source and the second base station source.

6. The DAS of claim 1, wherein the at least one access point uses a buffer to align the OTA symbols and frames for at least one of the first base station source and the second base station source to the common OTA frame boundary timing.

7. The DAS of claim 6, wherein the buffer is a circular buffer and the at least one access point stores frames from a packet-based source in the circular buffer for aligning with the common OTA frame boundary timing.

8. The DAS of claim 6, wherein the master unit provides delay information to one of the first base station source or the second base station source, wherein the delay information describes a delay caused by using the buffer to align the OTA symbols and frames.

9. The DAS of claim 1, wherein determining the common OTA frame boundary timing comprises receiving a frame boundary timing for the first base station source from the master unit, wherein when the master unit determines the frame boundary timing for the first base station, the master unit is configured to:
synchronize to a timing signal from a timing grandmaster, wherein the first base station source is synchronized to the timing grandmaster;
identify a system frame number and a subframe number based on a time of day calculated from the timing signal;
acquire configuration information for communications with the first base station source based on the system frame number and the subframe number; and
identify the frame boundary timing based on the acquired configuration information.

10. The DAS of claim 9, wherein the master unit synchronizes to the timing signal using precision timing protocol.

11. The DAS of claim 9, wherein the master unit acquires the configuration information by:
receiving signals from the first base station source,
identifying synchronization blocks in the received signals based on the system frame number and the subframe number; and
decoding the configuration information from the received signals.

12. The DAS of claim 11, wherein the master unit identifies the synchronization blocks by:
finding a location for the synchronization blocks based on the system frame number and the subframe number;
checking if the location contains the synchronization blocks;
determining if the location has a signal above a power threshold; and
correlating the signal at the location with a synchronization reference.

13. The DAS of claim 9, wherein when the first base station is an RF source, an RF donor card receives an RF signal from the first base station source.

14. The DAS of claim 13, wherein the RF donor card is configured to:
identify a center frequency and channel for the RF signal by determining a power level of the RF signal over a channel raster for different communication channels,
convert the RF signal to a digital signal; and
provide the digital signal to the master unit.

15. The DAS of claim 13, wherein the master unit provides the configuration information to the RF donor card.

16. The DAS of claim 13, wherein the RF donor card is at least one of:
mounted within a separate container from the master unit; and
directly connected to the master unit.

17. The DAS of claim 9, wherein the master unit aligns received signals to the frame boundary timing.

18. The DAS of claim 9, wherein the master unit is part of a time division duplexing system and the master unit identifies uplink periodicity and downlink periodicity based on the system frame number and the subframe number.

19. A radio access network (RAN) comprising:
a plurality of base station sources, wherein at least two base station sources in the plurality of base station sources have different OTA frame boundary timing; and
at least one radio unit coupled to the plurality of base station sources, the at least one radio unit configured to:
receive fronthaul data for the plurality of base station sources;
determine common OTA frame boundary timing; and
align OTA symbols and frames for the plurality of base station sources to the common OTA frame boundary timing.

20. The RAN of claim 19, wherein the at least one radio unit uses a buffer to align the OTA symbols and frames for the plurality of base station sources to the common OTA frame boundary timing.

21. The RAN of claim 20, wherein the buffer is a circular buffer and the at least one radio unit stores frames from a packet-based source in the circular buffer for aligning with the common OTA frame boundary timing.

22. The RAN of claim 19, wherein the at least two base station sources comprise an RF source and an O-RAN source.

23. The RAN of claim 22, wherein the at least one radio unit determines the common OTA frame boundary timing based on the fronthaul data received from the RF source.

24. The RAN of claim 19, wherein the at least two base station sources comprise packet-based sources.

25. The RAN of claim 24, wherein the at least one radio unit selects the common OTA frame boundary timing based on at least one of:
frame boundary timing of packets received from one of the at least two base station sources; and
a combination of the frame boundary timing of packets received from the at least two base station sources.

26. A method comprising:
receiving fronthaul data for a plurality of base station sources by an access point, wherein at least two of the plurality of base station sources have different frame boundary timings;
determining common frame boundary timing from the fronthaul data; and
aligning symbols and frames for the plurality of base station sources to the common frame boundary timing.

27. The method of claim 26, further comprising using a circular buffer to align the symbols and frames from a packet-based source in the plurality of base station sources to the common frame boundary timing.

28. The method of claim 26, further comprising, wherein the plurality of base station sources comprise an RF source and an O-RAN source, determining the common frame boundary timing based on the fronthaul data from the RF source.

29. The method of claim 26, further comprising, wherein the at least two base station sources comprise packet-based sources, selecting the common frame boundary timing based on at least one of:
frame boundary timing of packets received from one of the at least two base station sources; and
a combination of the frame boundary timing of packets received from the at least two base station sources.

30. The method of claim 26, further comprising providing delay information to one of the plurality of base station sources, wherein the delay information describes a delay caused by using a buffer to align the symbols and frames.

31. A system, comprising:
a timing grandmaster;
at least one base station that is synchronized with the timing grandmaster; and
a master unit coupled to the at least one base station, wherein the master unit is synchronized with the timing grandmaster, wherein the master unit is configured to:
determine the time of day based on the synchronization with the timing grandmaster;
identify a system frame number and a subframe number based on the time of day;
acquire configuration information for communications with the at least one base station based on the system frame number and the subframe number; and
identify frame boundary timing based on the acquired configuration information.

32. The system of claim 31, wherein the master unit acquires the configuration information by:
receiving signals from the at least one base station,
identifying synchronization blocks in the received signals based on the system frame number and the subframe number; and
decoding the configuration information from the received signals.

33. The system of claim 32, wherein the master unit identifies the synchronization blocks by:
finding a location for the synchronization blocks based on the system frame number and the subframe number;
checking if the location contains the synchronization blocks;
determining if the location has a signal above a power threshold; and
correlating the signal at the location with a synchronization reference.

34. The system of claim 31, further comprising an RF donor card, wherein when the RF donor card receives an RF signal from the at least one base station when the at least one base station is an RF source.

35. The system of claim 34, wherein the RF donor card is configured to:
identify a center frequency and channel for the RF signal by determining a power level of the RF signal over a channel raster for different communication channels,
convert the RF signal to a digital signal; and
provide the digital signal to the master unit.

36. The system of claim 31, wherein the at least one base station is an ORAN base station and the master unit identifies the system frame number and the subframe number in signals received from the at least one base station.

37. The system of claim 31, wherein the master unit aligns received signals to the frame boundary timing.

38. The system of claim 31, wherein the master unit is part of a time division duplexing system and the master unit identifies uplink periodicity and downlink periodicity based on the system frame number and the subframe number.

39. The system of claim 31, wherein the master unit provides the frame boundary timing to an access point, wherein the access point uses the frame boundary timing as a common OTA frame boundary timing.

40. A method comprising:
determining a time of day based on synchronization with a timing grandmaster, wherein at least one base station is synchronized to the timing grandmaster;
identifying a system frame number and a subframe number based on the synchronization;
acquiring configuration information for communications with the at least one base station based on the system frame number and the subframe number; and
identifying a frame boundary timing based on the acquired configuration information.
